(19) United States
(12) Patent Application Publication
(10) Pub. No.: US 2026/0157392 A1
(43) Pub. Date: Jun. 11, 2026

(54) APPARATUS TO INJECT INDIVIDUAL FOOD ITEMS INTO A FLOWING BASE PRODUCT

(71) Applicant: Flavor Burst, LLC, Danville, IN (US)

(72) Inventors: Thomas J. Gerber, Danville, IN (US); Timothy Gerber, Danville, IN (US); Daniel Jackson, Danville, IN (US)

(21) Appl. No.: 19/412,079

(22) Filed: Dec. 8, 2025

Related U.S. Application Data
(60) Provisional application No. 63/729,690, filed on Dec. 9, 2024.
(60) Provisional application No. 63/907,612, filed on Oct. 29, 2025.

(51) Int. Cl. A23G 9/28; A23G 9/48

(52) U.S. Cl. CPC A23G 9/288; A23G 9/48

(57) ABSTRACT

An apparatus for injecting food items into a flowable frozen base product is provided. The apparatus includes a housing with a plurality of separate storage and metering assemblies, each is configured to receive a volume of individual food items, the housing includes a receipt volume that is aligned with an output of individual food items from each of the plurality of storage and metering assembly. An auger assembly that receives food product from an outlet of the receipt volume and during operation of the auger assembly combines the individual food items received therein with a flowable frozen food product that is received within the auger assembly such that a flows out of the auger assembly. The apparatus may include a lifting mechanism that can transfer the housing from a use position above the machine to a lowered position to allow easy access to the housing.

### CROSS-REFERENCE TO RELATED APPLICATIONS

This application claims priority from U.S. Provisional Application No. 63/729,690, filed on Dec. 9, 2024, and from U.S. Provisional Application No 63/907,612, filed on Oct. 29, 2025, the entirety of each are hereby incorporated by reference herein.

### BACKGROUND OF THE INVENTION

This application relates to a system that can inject individual food items into a stream of flowable frozen food that is prepared by a machine for flowable frozen food.

### SUMMARY OF THE INVENTION

A first representative embodiment of the disclosure is provided. The embodiment is an apparatus for injecting food items into a flowable frozen base product. The apparatus includes a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly. An auger assembly is provided that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly. The housing is configured to be movably fixed to a machine that is configured to produce the flowable frozen base product, wherein the housing can be disposed in a use position where the housing rests above the machine and the housing can be disposed in a lowered position wherein the housing is disposed outboard of and in a position wherein the housing is disposed vertically below the use position. The housing comprises a bracket that is fixed to a surface thereof, the bracket is connected to a lifting mechanism that is configured to be installed upon and fixed to a machine housing of the machine configured to produce the flowable frozen base product. The bracket can rotate with respect to the lifting mechanism with a rotational axis that is oriented in parallel with a longitudinal axis of motion of the lifting mechanism.

Another representative embodiment of the disclosure is provided and includes an apparatus for injecting food items into a flowable frozen base product. The apparatus includes:
a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly;
   an auger assembly that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly.

Further representative embodiments of the disclosure include the Numbered Paragraphs 1-85 and any combinations thereof that would be desired by one of ordinary skill in the art after a thorough review and understanding of this specification.

A further representative embodiment of the disclosure includes the methods of Numbered Paragraphs 61 and 62.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an apparatus to inject individual food items into a flowing base product, such as soft serve ice cream dispensed from a draw valve of a machine, with the apparatus in the use position.

FIG. 1A is a view of detail A of FIG. 1.

FIG. 1B is a perspective view of the apparatus in a lowered position with respect to the machine.

FIG. 2 is a rear perspective view of the apparatus of FIG. 1 in the use position.

FIG. 3 is an upward perspective view of the apparatus of FIG. 1.

FIG. 3A is the view of FIG. 3 showing the housing for a transmission removed.

FIG. 4 is a top perspective view of the housing of the apparatus of FIG. 1 with the side surfaces and the top removed, and with one of the storage and metering assemblies removed.

FIG. 5 is a perspective sectional view of cross-section BB-BB of FIG. 4.

FIG. 6 is a bottom perspective sectional view of a storage and metering assembly, sectioned to depict the distribution compartment thereof.

FIG. 7 is a bottom perspective sectional view of a storage and metering assembly, sectioned to depict the bottom surface and the outlet hole of the storage and metering assembly.

FIG. 8 is a top perspective view of the storage and metering assembly, sectioned to depict a bottom portion of the storage volume and the upper hole.

FIG. 9 is a top perspective view of the storage and metering assembly in the same orientation as the storage and metering assembly of FIG. 8, sectioned to depict the distribution compartment and the outlet hole, depicting a gear with four teeth (other embodiments can be used that would include five or more evenly spaced teeth instead as discussed herein).

FIG. 10 is an exploded view of the components of the auger assembly of the apparatus of FIG. 1.

FIG. 11 is a perspective view of the components of the lifting assembly of the apparatus of FIG. 1.

FIG. 11A is rear perspective view of the lifting assembly of FIG. 11.

FIG. 12 is a top perspective view of a modified auger assembly usable with the apparatus of FIG. 1.

FIG. 13 is a perspective cross-sectional view of Section EE-EE of FIG. 12.

FIG. 13A is a view of detail PP of FIG. 13.

FIG. 14 is a perspective view of a tube of the auger assembly of FIG. 12.

FIG. 15 is a side view of the tube of FIG. 14 in a first rotational position.

FIG. 16 is the view of FIG. 15 with the tube rotated 90 degrees.

FIG. 17 is a top view of the tube of FIG. 14.

FIG. 18 is a bottom perspective view of a gear and transmission of the auger system of FIG. 12.

FIG. 19 is a different perspective view of the gear and transmission of FIG. 18.

### DETAILED DESCRIPTION OF THE INVENTION

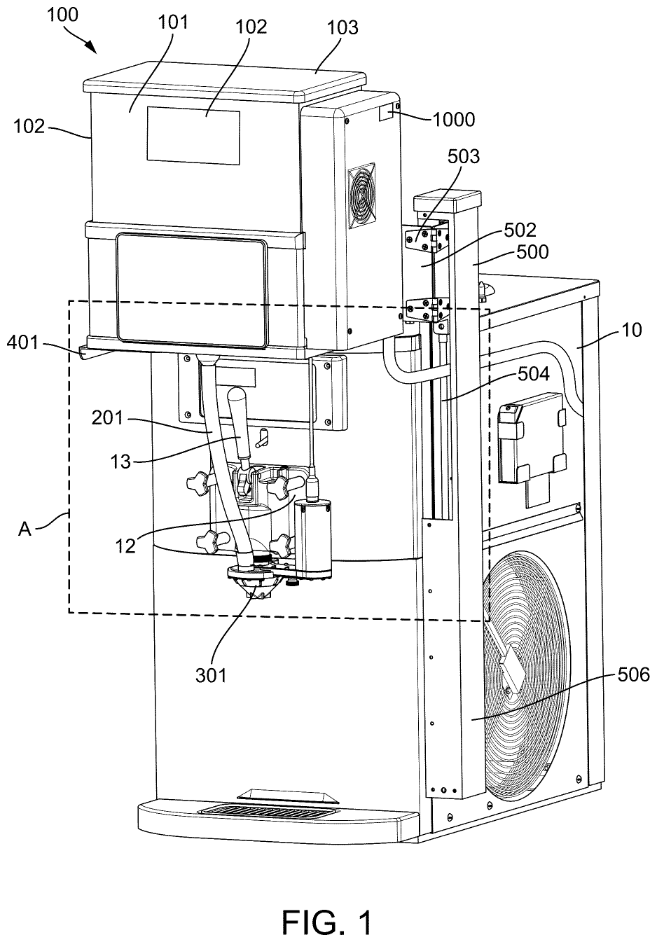

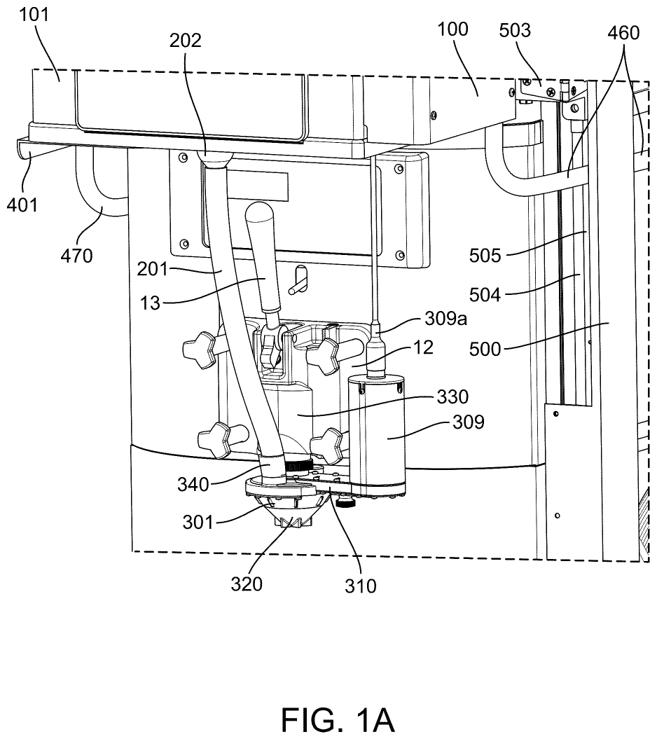

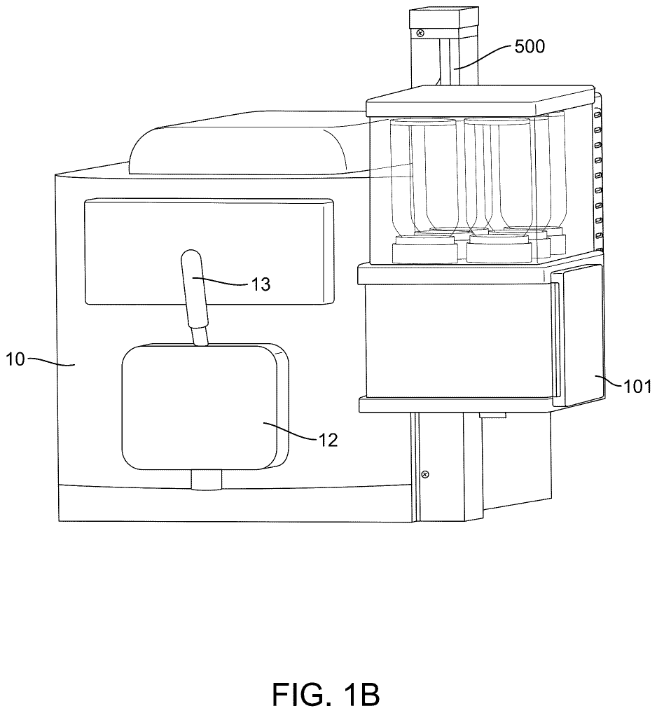

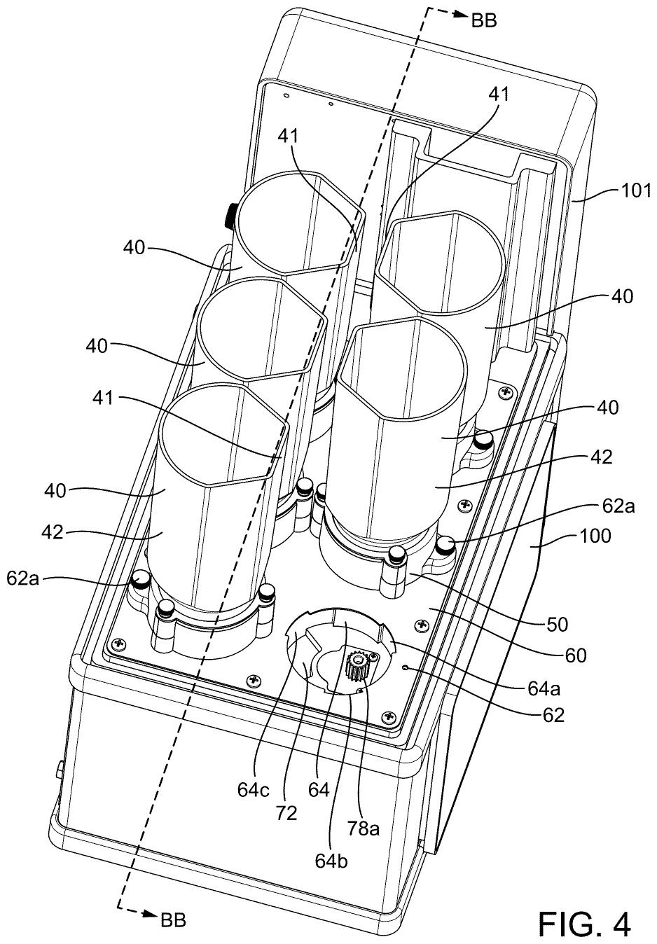

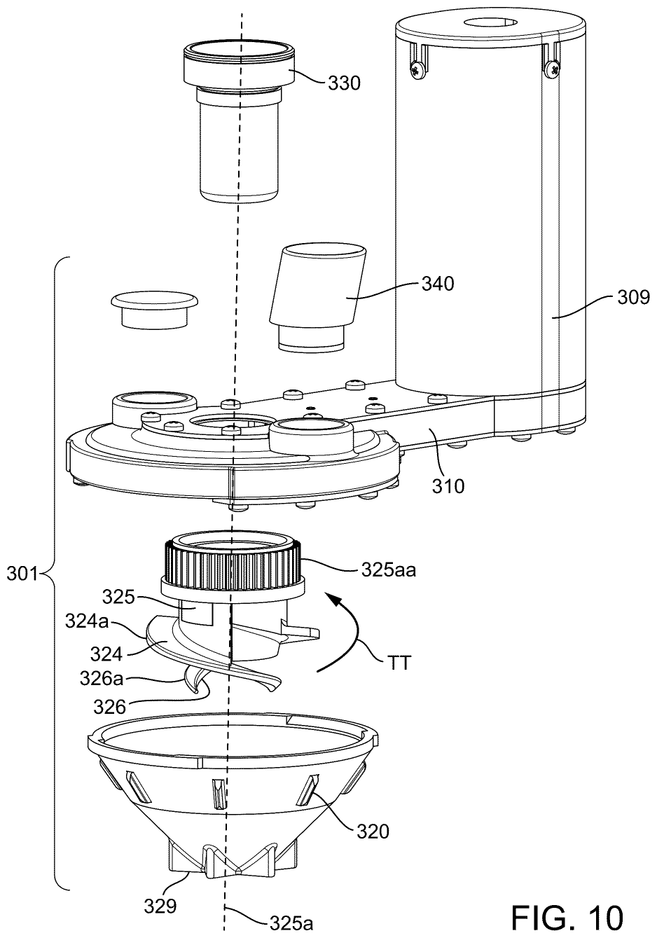

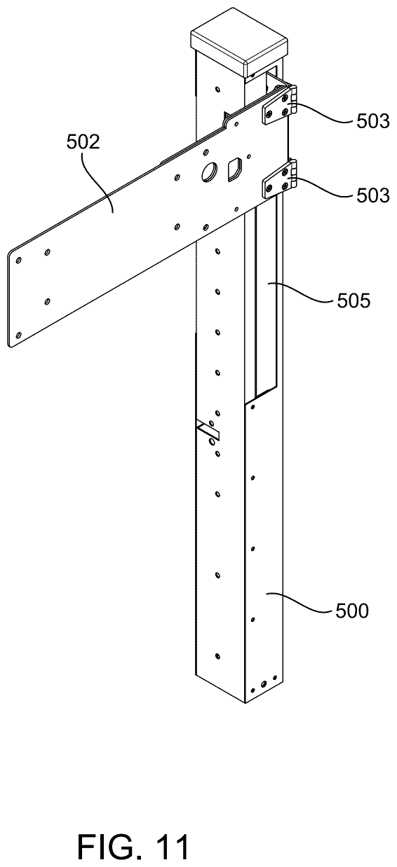

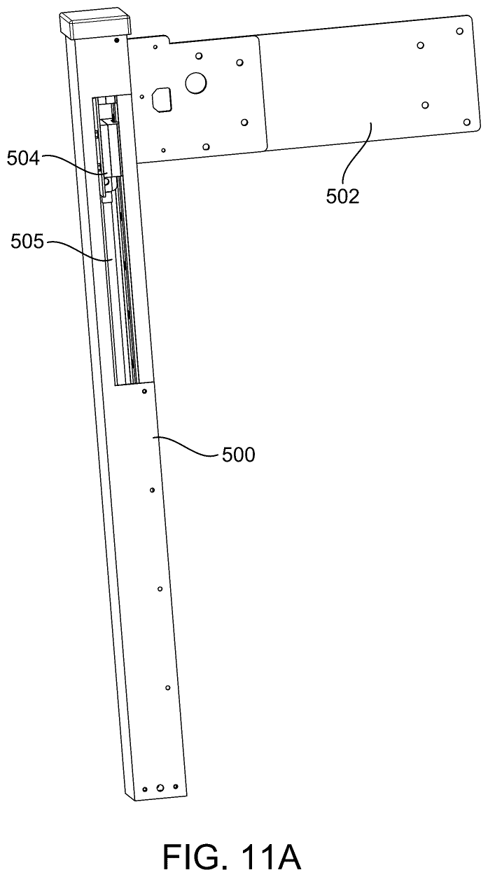

Turning now to FIGS. 1-11A, an apparatus 100 for injecting food items into a flowable frozen base product 100 is provided. The apparatus and system 100 is intended to be used with a machine that produces a flowable frozen base product, such as a machine configured to produce “soft serve” ice cream, frozen yogurt, milkshakes, frozen beverages, frequently referred to as frozen drink machines, and the like. The apparatus 100 is configured to be readily used to be positioned upon and interact with a machine 10 that produces flowing frozen base product, with the apparatus being connected to (both mechanically and in some embodiments electrically) the machine after the machine 10 has been manufactured in accordance with its specifications. In some embodiments, the apparatus 100 may be connected with the machine 10 when the machine is positioned within the restaurant or desired position for use. In other embodiments, the apparatus 100 may be connected to the machine 10 at the factory that manufactures the machine 10 (or sold together with the machine 10 with the apparatus being assembled upon the machine 10) at the facility. The apparatus 100 may be used with other machines than machines for flowing frozen food.

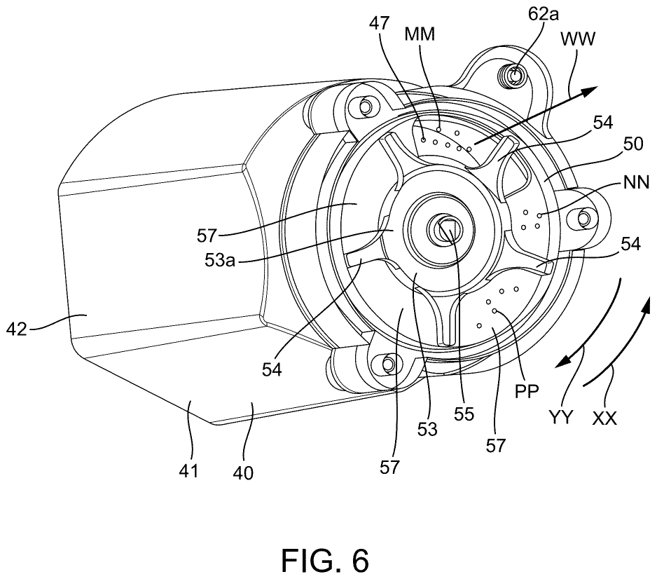

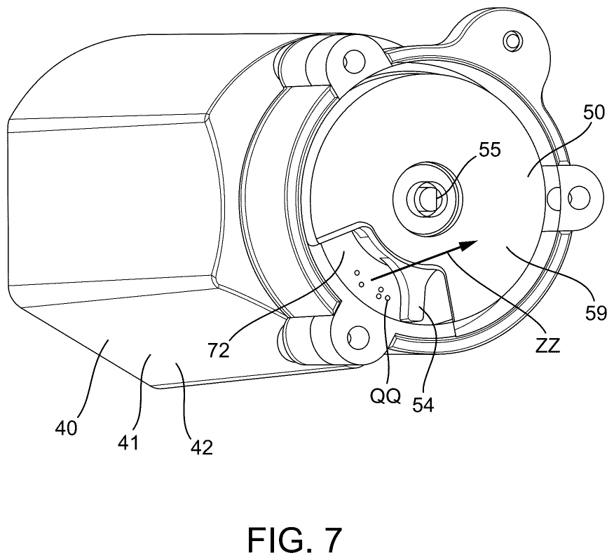

The apparatus 100 includes a housing 101 that receives a plurality of storage and metering assemblies 40 that each are configured to hold a volume of individual food items therein. The storage and metering assemblies 40 are each aligned to, when desired or called for by a recipe, drop one or several individual food items QQ (FIGS. 6 and 7, schematic) into a receipt volume 80 that is disposed vertically below the plurality of storage and metering assemblies 40. In a preferred embodiment, as depicted in the figures, a single receipt volume 80 is provided and is aligned vertically below an outlet hole 72 of all of the storage and metering assemblies 40, such that individual food items QQ that are released (fall) from each of the storage and metering assemblies 40 fall into the same receipt volume 80. In other embodiments, each storage and metering assembly 40 may have its own receipt volume 80, with those all connected together such that individual food items that fall into each receipt volume then fall into the tube 201 and to the auger assembly 301. The tube 201 includes a funnel opening 202 that is configured to engage an outlet 82 of the receipt volume, such with a friction fit therebetween, but to be removable from the outlet 82, such as by pulling the funnel opening 202 off of the outlet 82 with some downward force when the tube 201 is to be disengaged from the outlet, such as for cleaning, or when the housing 101 is to be moved from the normal position above the machine 10 using the lifting mechanism.

The apparatus 100 further includes an auger assembly 301 that receives both the individual items from the receipt volume 80 and also may simultaneously receive a flow of frozen base product from the machine 10 and specifically the draw valve 13 of the machine, and with operation of the auger assembly 301, the individual items mix with the flow of frozen base product, such that a mixture of the two (specifically the individual food items mixed within the flowable frozen product) that flows out of an outlet 329 of the auger assembly 301, such as into an ice cream cone, into a bowl, or a cup or the like for consumption by the user.

The housing 101 preferably includes an input device 102, or can communicate with an input device, such as when the input device 102 is disposed within a remote system such as a computer, a phone, a wireless system, a networked system, a satellite based system, is disposed as a part of an input device of the machine 10, or may be disposed upon another piece of equipment that is attached to the machine 10 (physically attached, or electronically attached—such as a flavoring system that operates in conjunction with the machine 10. The term “associated with the housing” includes an input device that is disposed upon the housing as well as one that can communicate with a control system 1000 that can control the operation of the systems 40, 301 discussed below of the apparatus 100. The input device 102 can receive instructions to mix one or more types of individual food items (that are disposed within the plurality of storage and metering assemblies 40 within the housing 101) and cause operation of the various storage and metering assemblies (as discussed below) to provide sequentially or in parallel the flow of the desired individual items into the auger assembly 301, as discussed below.

The apparatus 100 is connected to the machine 10 in a movable manner such that a housing 101 for the apparatus when positioned for use (FIG. 1) (as discussed above and elsewhere herein) is disposed entirely or with a portion vertically above the machine 10 and preferably resting upon a top surface of the machine 10, either directly upon the top surface of the machine, or as in the embodiments depicted herein, upon a platform 401 that rests upon the top surface of the machine 10. The housing 101 may be moved to a lowered position (FIG. 1B) where the housing 101 no longer is vertically above the machine and is positioned proximate to a side surface of the machine.

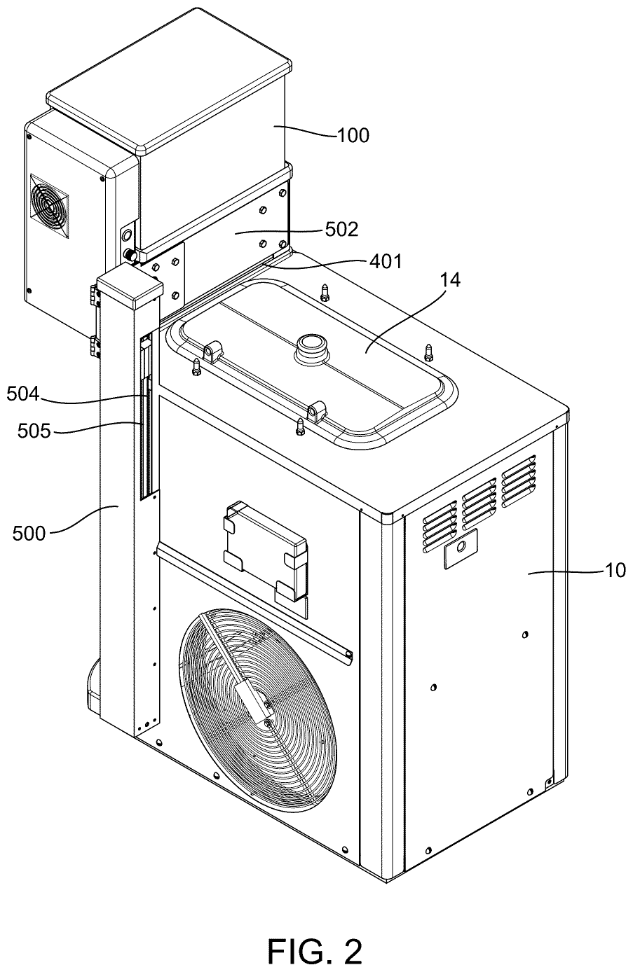

The apparatus 100 includes a movement mechanism 500 that connects to the housing 101 via a bracket 502 and a lifting mechanism 501 that supports the bracket 502. The bracket 502 may be connected to the lifting mechanism 501 with one or more hinges 503, which allows the bracket 502 (and therefore the housing 101) to rotate with respect to the lifting mechanism 501. The lifting mechanism 501 allows the bracket 502 and the housing 101 to be raised and lowered with respect to the machine 10 (when the bracket and housing 101 have rotated to a position clear of vertical alignment with the machine 10) and can rest in a lowered position (FIG. 1B) with respect to the machine 10. The lifting mechanism includes an assist mechanism, such as a piston (or damper) 504 disposed within the lifting mechanism. The piston 504 is configured to be compressed when the bracket 502 and the housing 101 are lowered with respect to the machine 10, which allows the bracket 502 and the housing 101 to be lowered with respect to the machine 10 in a controlled manner. The piston 504 is configured to give an “assist” when the bracket 502 and the housing 101 are lifted from a lowered position with respect to the machine to a raised position where the bracket 502 can be rotated to a position where the housing 101 rests above the machine 10, such that the user that is urging the bracket 502 and the housing 101 to raise with respect to the machine 10 does not need to lift the entire weight of the housing 101 to have the bracket 502 and housing 101 to move vertically upward with respect to the machine 10. When the bracket 502 and housing 101 reach the top of the possible vertical travel of the lifting mechanism 501, the bracket 502 and the housing 101 are rotated by the one or more hinges 503 until the housing reaches a position where it is aligned as desired above the machine 10 as depicted in FIGS. 1 and 2.

The movement mechanism 500 will be understood by one of ordinary skill in the art to provide several advantages. Specifically, the movement mechanism 500 allows the housing 101 to, during operation, rest vertically above the machine, such that individual food items (e.g. QQ) as desired will be inserted into the flow of frozen food product within the auger assembly 301 (and from the housing 101 that is vertically above the auger assembly 301) when desired by the user with a relatively simple design to allow for normal operation. The housing 101 can be readily moved to a lower position when it is desired to refill one or more of the storage volumes 42 within each storage and metering assembly 40 so that employees can do so without the need of ladders or similar. The housing 101 can also readily be moved away from a position vertically above the machine 10 to allow additional mixture/ingredients for forming the flowable frozen base product to be added to the machine, which typically is through a holding compartment 14 at the top of the machine 10. The movement mechanism 500 additionally allows for ergonomic and repeatable motion of the housing 101 and bracket 502 with respect to the machine 10—to allow virtually any employee to safely move the housing 101 with respect to the machine.

The movement mechanism 501 further includes in the lifting mechanism a space 505 that extends therethrough that allows for flexible elongate members, such as cords and tubes (460, FIG. 1A) that connect to the housing 101, to extend therethrough (FIG. 1, schematic) to organize the cords/tubes for as the housing 101 moves between the use position (FIG. 1) and the lowered position (FIG. 2), which prevents the cords and tubes from kinking or collapsing as the housing moves. The cords/tubes 460 that extend through the space 505 may be a power cord for the housing 101 (to power the motors for the storage and metering assemblies 40 (discussed below) as well as a controller 1000 and various sensors within the housing 101 discussed below. Tubes may be a drainage tube to allow for liquid to drain from within the housing 101.

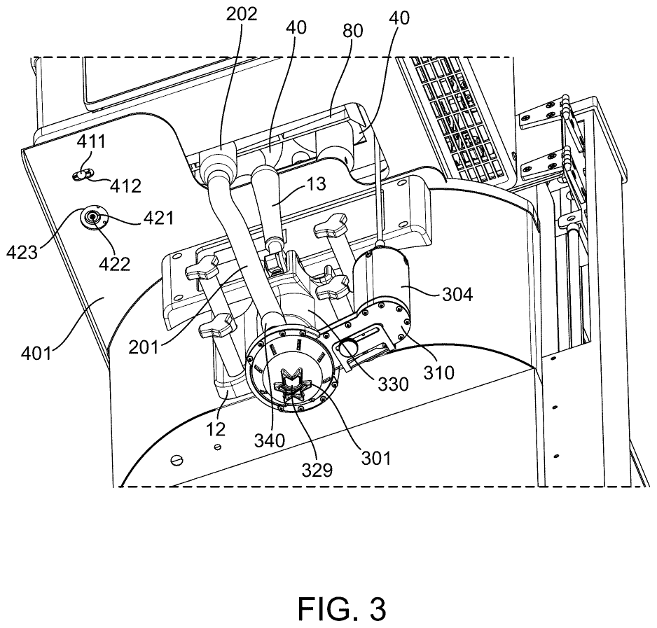

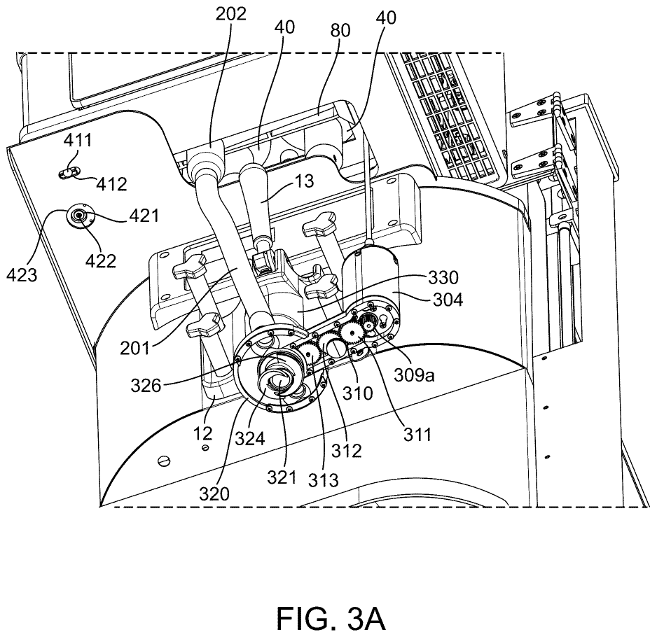

The platform 401 is best shown in FIGS. 3 and 3A and includes a surface upon which a portion or all of the housing 101 rests when the housing is in the use position (FIG. 3A). The housing 101 is moved off of the platform 401 when moved to the lowered position (FIG. 1B). In some embodiments, the platform may include an aperture (412, FIG. 3) or a recess (that extends downwardly from a top surface of the platform through a portion of the thickness of the platform 401) instead of an aperture. The housing 101 includes a detent 411 (such as a spring loaded ball) that extends into the aperture 412 (or recess) when the housing 101 is properly positioned upon the platform 401 to provide final guidance for the housing 101 to be positioned as designed upon the platform 401. The interaction between the detent 411 and the aperture or recess additionally prevents vibration of the housing 101 from potentially causing the housing from rotating out of place during use.

The platform 401 additionally may include a second aperture 423 that when the housing 101 is properly positioned, exposes an electrical connector 421 disposed upon the bottom surface of the housing 101, such that an electrical cable 470 can connect with the electrical connector 421 (through the second aperture 423) when the housing 101 is properly positioned upon the platform 101. The electrical cable 470 may be a cable that connects the housing 101 with the machine 10 a controller 1000 can receive various signals from the machine 10 (e.g. draw valve operation, and potentially instructions and/or from a controller within the machine, or a user input upon (either directly upon the machine, or in communication with the machine) or associated with the machine. In some embodiments, the electrical connector 421 and the corresponding cable may have corresponding magnetic connectors such that the cable and the electrical connector 421 are maintained in connection with magnetic force (such as against the force of gravity that would tend to cause the cable from falling downwardly and out of connection with the electrical connector 421. In a preferred embodiment, one or both of the of the electrical connector 421 or the cable have a spring loaded contact 422 or electrical terminal or connection point that is biased to engage a corresponding contact (or the like) in the other of the electrical connector 421 or cable to encourage an electrical connection therebetween, and preferably when the opposite magnetic connectors of the electrical connector 421 and the cable are magnetically coupled together.

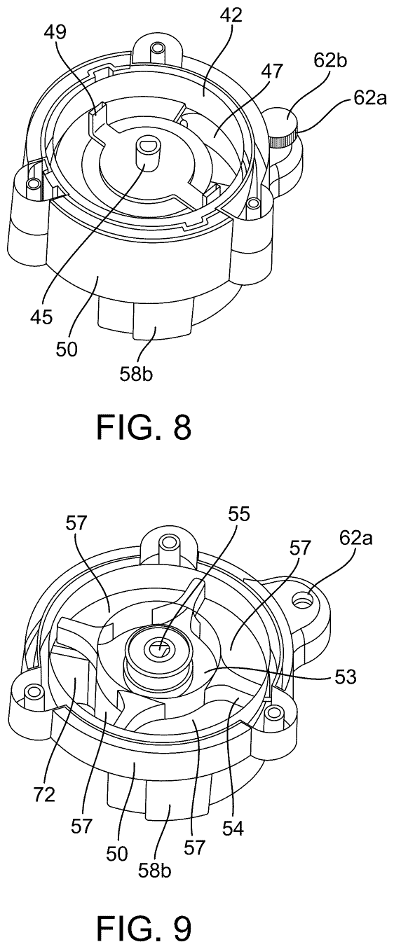

The housing 101 is understood with review of FIGS. 3-9. The housing 101 includes an enclosure that supports and encloses a plurality of storage and metering assemblies 40, and with operation of the one or more of the storage and metering assemblies 40 causes individual food pieces (e.g. MM, NN, QQ—FIGS. 7 and 8) to be drawn within their respective storage volumes 42, and into a receipt volume 80 that is disposed below the storage volumes 80. The housing 101 may include a plurality of storage and metering assemblies 40 that may each house different types of individual food items that may be desired by a user (end customer or restaurant employee that prepares an item for a customer), such as individual candies (e.g. M&Ms ™, chocolate chips, candy bar pieces, cookie pieces, cereals, and the like). In the embodiment depicted herein the housing 101 includes 6 separate storage and metering assemblies 40 that can be operated (by a controller 1000, discussed below) individually, in an alternating fashion with other assemblies 40 or in parallel with (i.e. during the same time as) other assemblies 40. In other embodiments a housing 101 may include other numbers of storage and metering assemblies (e.g. 4, 5, 7, or 8) and would be constructed in the same manner as disclosed herein.

The housing 101 includes side walls 102 and a top wall/lid 103 that can be removed to access the storage volumes 42, which preferably themselves are open for ease of refilling when the lid 103 is removed. The housing 101 includes a support tray 60 upon which each storage and metering assembly 40 rests, and a corresponding number of apertures 64 therethrough to the number of storage and metering assemblies 40. Each aperture 64 may include one or more keyways (e.g. 64a, 64b, 64c) with the storage and metering assembly 40 including one or more corresponding keys (e.g. 58b) that allow for the storage and metering assembly 40 to only be able to be inserted into the aperture 64 in a specific orientation, to align the outlet hole 72 (discussed) to be aligned directly above the receipt volume 80, such that food items that fall out of the outlet hole 72 fall directly into the receipt volume 80.

In some embodiments, the storage volume 42 may be cylindrical. In some embodiments, the storage volume 42 may be curved (with or without a constant radius) for a portion of the circumference thereof, and may include a flat portion 41 that is above the outlet hole 72 (discussed below), which in some embodiments allows for the storage volumes of proximate and facing storage and metering assemblies 40 to be placed closed to each other than would be possible if the storage volume 42 was round throughout its entire circumference. The existence of the flat portion 41 provides space for individual storage and metering assemblies 40 to be rotated with respect to adjacent in place storage and metering assemblies 40. Additionally, the flat portion 41 serves to prevent the agitator 49 from causing the individual food pieces from rotating through the entire circumference of the storage volume 42 as the agitator rotates, instead the flat portion 41 prevents fully rotation and therefore causes individual food pieces to fall through the upper hole 47 as the agitator rotates.

In some embodiments, the support tray 60 may include a locating hole 62 outboard of the aperture 64. The locating hole 62 is configured to receive a pin, such as a spring loaded pin 62a therewithin when the storage and metering assembly 40 is properly positioned upon the support tray 60. The pin 62a may have an operator 62b disposed thereon and that extends upwardly from the assembly 40 to allow a user to pull the pin 62a upwardly and out of the locating hole 62 when it is desired to remove the assembly 40 from the support tray 60.

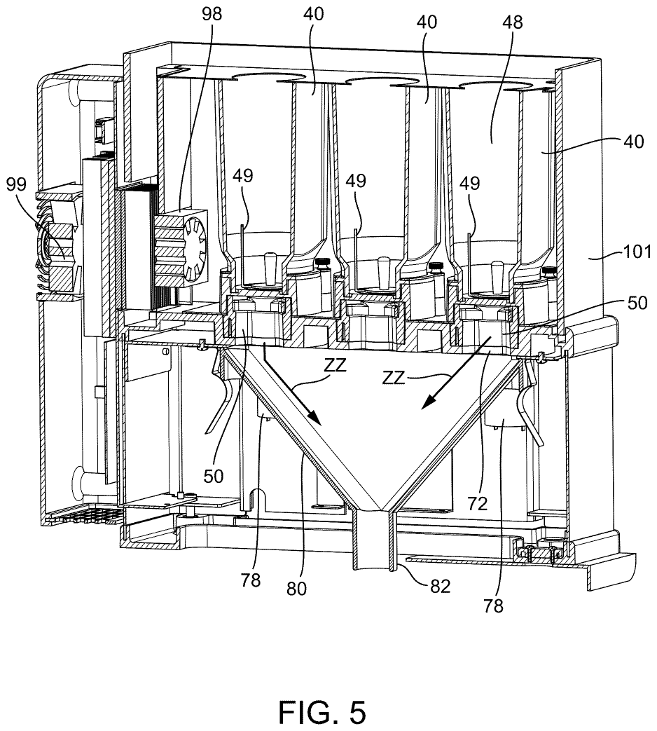

The storage and metering assembly 40 is best shown in FIGS. 5-9. The assembly includes a storage portion 48, within which a volume of individual food items to be dispensed may be stored. The storage portion 48 may include an agitator 49 to mix individual food items within the storage portion. The agitator 49 may be directly connected to the motor 78 that is provided with each assembly 40, or the agitator 49 may be connected to the motor 78 via a transmission, and in some embodiments a transmission and a clutch, to allow for the agitator 49 to only selectively rotate when the shaft of the motor 78 rotates. The agitator 49 may include one or more vertical arms that extend upwardly into the storage portion 48 to move the individual food items with respect each other, as well as to move the individual food items to allow food items to fall through an upper hole 47 and into the distribution compartment 50. The storage portion 48 includes a bottom floor 57 that lowest individual food items rest upon and forms the upper hole 47 and downwardly into the distribution compartment 50.

The distribution compartment 50 in FIGS. 6 and 7 and is separated from and below the storage portion, with an upper hole 47 within the bottom floor 57 allowing movement into the distribution compartment 50. The distribution compartment 50 includes a bottom surface 59 that includes an outlet hole 72 disposed therein. The bottom surface 59 is disposed at an opposite end of the distribution compartment 50 as the bottom floor 57, with the bottom floor 57 also providing the upper bounds of the distribution compartment 50.

The distribution compartment 50 includes a gear 53 that is rotatably mounted there (via a shaft 55) and includes a plurality of radially extending teeth 54 that extend radially from a hub 53a of the gear 53. The gear 53 is rotated by torque provided by the motor 78. In some embodiments, the gear 53 may be directly connected to the motor shaft. In a preferred embodiment, the a transmission, such as an intermediate gear is disposed to transfer torque from the motor shaft to the gear 53. The gear 53 may be directly connected to the motor, or may be connected via a transmission, and the gear 53 may be connected to the motor with a clutch to allow the motor 78 to rotate in some circumstances with the gear 53 remaining stationary. The gear 53 is preferably sized with the height of the gear teeth 54, and in some embodiments also the hub 54, being just shorter than the vertical distance between the bottom floor 57 and the bottom surfaces 59 (specifically the distance between the portions of the bottom floor 57 and the bottom surface 59 that face into the distribution compartment) so that there is minimal space between the upper and lower surfaces of the gear teeth 54 and the respective facing surface of the bottom floor 57 and the bottom surface 59—so that individual food items that fall into the distribution compartment 50 do not fit between the upper/lower surfaces of the gear teeth 54 and the respective bottom floor 57 or bottom surface 59.

The gear 53 is provided with teeth 54 that are preferably evenly spaced therearound, so that a consistent spacing between gear teeth 54 is established. In a preferred embodiment, the gear 53 has 5 teeth 54 that are evenly spaced, such that a consistent space is provided between adjacent teeth (with the space formed by the two adjacent teeth, the outer circumferential surface of the side wall of the distribution compartment 50 and the combined bottom floor 57 (forming the ceiling of the distribution compartment 50) and the bottom surface 59 (forming the floor of the distribution compartment 50). In other embodiments, the gear may have 6, or 8, or other numbers of equally spaced gear teeth 54, which would decrease (or increase with less teeth than 5) the space between adjacent teeth and therefore decrease the volume of individual food pieces that are disposed within the space, as discussed below. The teeth 54 may be straight and extend radially outward from the hub 53a, or the teeth may be curved or arranged in other manners, for the purpose of altering the geometry of the space (as defined above) as the spaces interact with the above hole 47 in the bottom floor 57, or the outlet hole 72 in the bottom surface 59.

The outlet hole 72 is arranged upon the bottom surface 59 preferably at a position that is on the opposite side of the distribution compartment 50 from the hole 47. The outlet hole 72 (when the storage and metering assembly 40 is properly positioned within the aperture 64 (discussed above) is positioned directly above a portion of the receipt volume 80, such that individual food pieces that fall through the outlet hole 72 (arrow ZZ of individual food pieces QQ positioned above the outlet hole 72, schematic) fall into the receipt volume 80, as depicted in FIG. 5 (arrows ZZ). FIGS. 8 and 9 are sectional views of a lower portion of the storage volume 48 (depicting hole 47) and a section of the distribution compartment 50 (depicting hole 72) that are from the same perspective of the overall storage and metering assembly 40 to depict how the outlet hole 72 is provided on an opposite side of the hole 47. The term “opposite side” is defined as the exact opposite side (i.e. with centers 180 degrees apart) but to also include positioned apparat such that the gear 53 may be arranged within the distribution compartment such that at least one space (as discussed below) can be positioned completely separated from the geometry of both the hole 47 and the outlet hole 72 so that a volume of individual food items (e.g. NN or PP, FIG. 6) can be positioned within one or more spaces before being aligned with the outlet hole 72).

The distribution compartment 50 is arranged to receive individual food items (e.g. MM, FIG. 6, schematic) that fall through the hole 47 in the bottom floor 57 of the storage portion that fall into a space that is aligned between two gear teeth 54 (arrow WW, FIG. 6). As the gear 53 rotates, the individual food items that are within the space also move within the distribution compartment 50. FIG. 6 depicts a plurality of individual food items (NN, schematic) that are within a space that has rotated in the direction YY with rotation of the gear 53 from a position that is directly under the hole 47. FIG. 6 further shows another plurality of food items (PP, schematic) that has further rotated in the direction YY away from a position directly under the hole 47.

In some embodiments, the motor 78 is operated by a controller 1000 (schematic) such that the gear 53 within the distribution compartment 50 rotates in the direction YY (FIG. 6) when a volume of individual food pieces is called for to travel to the auger assembly 301. Specifically, when it is desired to receive food items (of the kind within the specific storage and metering assembly 40), the motor 78 rotates (specifically the motor shaft) which causes the gear 53 to rotate in the direction YY. The rotation of the gear 53 causes the space between adjacent gear teeth to move also in the direction YY. The movement of the space causes the space closest to the outlet hole 72 to move until space is above the outlet hole 72, which causes the individual food items to fall through the outlet home 72 and into the receipt volume 80. In some embodiments, the motor is configured to rotate in the direction YY until a single space is aligned over the outlet hole 72, and then rotate briefly in the opposite direction (XX, FIG. 6) to withdraw the space from being aligned over the outlet hole 72. Depending upon the volume of the specific individual food item that is desired to travel into the auger assembly 301, the motor 78 may initially rotate in direction YY such that two or more spaces travel above the outlet hole 72 to cause the volume of individual food pieces to fall into the receipt volume 80 and travel into the auger assembly 301. The rotation in the opposite direction XX is to move the space most adjacent to the outlet hole 72 further away from the outlet hole to prevent unwanted individual food items from falling through the outlet hole 72, which might occur if the adjacent space is too close to the outlet hole 72, such as due to vibrations caused by operation of the various motors within the housing 101, or vibrations transferred to the housing 101 due to the operation of the machine 10.

The receipt volume 80 is preferably disposed vertically above the auger assembly 301 and aligned in a position with a substantial vertical vector component in a line between the auger assembly 301 and the outlet 82 of the receipt volume 80 such that the individual food pieces that fall into the receipt volume 80 fall downwardly through tube 201 through a path that is aligned with a substantial vertical vector component.

In some embodiments, the housing 101 may include a cooling system 98 (which may be a thermoelectric) and a fan 99 to stir the air within the housing, which may be an exhaust fan.

The auger assembly 301 is best shown in FIGS. 1A, 3, 3A, and 10. The auger assembly 301 includes a first inlet 330 that is disposed to allow a flow of flowable frozen base product to flow therethrough, which typically flows from an outlet of the draw valve 13 that is disposed upon a freezer door 12 of the machine, and a second inlet 340 that is connected to the tube 201 that is connected to an outlet of the receipt volume 80. In the embodiment depicted in the figures, the first inlet 330 is disposed in the center of the auger assembly 301 (preferably along a centerline) and the second inlet 340 is disposed outboard of the first inlet 330.

The first inlet 330 may connect to a tube 325 such that flow through the first inlet flows through the tube 325 toward the outlet.

The auger assembly includes a housing 320 that encloses a space within the assembly, and includes an outlet 329 that allows for flow out of the auger assembly 301. The space receives flow from the inlet (typically the second inlet 340) and one, two, or more curved paths 324, 326 that extend from a top portion of the housing 320 and toward the outlet 329 and may be fixed to a tube 325 that extends through the housing. The tube 325, when provided, is the tube that is connected to the first inlet 330. The curved paths 324, 326 may act as threads in an auger such that individual food items that are received within the auger assembly 301 move down the curved paths toward the outlet 329. The end tips of the curved paths 324, 326 are proximate and are pointed toward an outlet of the tube 325, such that individual food items that travel along the curved paths 324, 326 are directed into a path that leaves the tube 325 downwardly toward the outlet 329. The inner surface of each curved path 324, 326 is fixed to an outer circumference of the tube 325. The curved paths include respective outer edges 324a, 326a along its length that extends to or to a very close position with respect to an inner side surface of the auger housing 320. The outlet 329 may be star shaped or in another shape to extrude a cross-sectional shape of the flow of flowable frozen food (plus individual food items therewithin) as desired.

The tube 325 and the curved paths 324, 326 are rotatable along the centerline 325a through the tube 325, such that the curved paths 324, 326 rotate within the housing 320. The rotation causes the individual food items that enter into the auger housing 301 and travel along the curved paths 324, 326 to also enter into the flow food from the tube 325 at different rotational locations with respect to the tube 325. The auger assembly 301 may include a motor 309 that is connected with respect to the auger assembly such that torque from the motor 309 is transferred to cause rotation of the tube 325 and the curved paths 324, 326. The motor 309 may be connected to the tube 325 via a transmission 310. In the embodiment depicted in the figures, the tube 325 includes a plurality of gear teeth 325aa about the outer circumference thereof that are in mesh with a gear 313 within the transmission (FIG. 3A) that receives torque from the motor shaft 309a. One embodiment of the transmission 310 is depicted in FIG. 3A, and different transmissions (such as a belt drive or different arrangements (numbers and sizes for different gear ratios) may be provided to transfer torque from the motor shaft 309a to the tube 325.

The motor 309 may be controlled by a controller (1000), which may be the same controller that operates the housing 101 or may be a different controller that is in communication with the controller that operates the housing. The controller may operate such that when the draw valve 13 of the machine is operated to cause flow of a flowable frozen base product from the machine, the controller receives a signal indicating movement of the draw valve, which causes the motor 309 to begin operating, which rotates the tube 325 and specifically the curved paths 324, 326. In some embodiments the controller 1000 is configured such that it will not operate any of the motors 78 of the separate storage and metering assemblies 40 unless the controller 1000 receives a signal that the draw valve has been moved in the open direction. In some embodiments, the controller 1000 will not operate any of the motors 78 of the separate storage and metering assemblies 40 unless the controller 1000 also receives a signal (generally from the input 102 in communication with the apparatus 100, but also could be from a pre-programmed recipe) that certain individual food items that are stored within the various storage and metering assemblies 40 are desired for injecting into the flowable frozen food that is being dispensed from the draw valve 13 and into the auger assembly 301. As discussed above, in circumstances when multiple different types of individual food items (which are stored in specific different storage and metering assemblies 40), the controller 1000 may operate the respective motors of the specific storage and metering assemblies 40 that include the desired individual food items in series (i.e. cause one motor and gear (78, 53) to rotate in the direction YY to move one space full one desired individual food item to move so that those fall through the hole 72 and into the receipt volume 80 and then stop that motor and gear, and then start a motor/gear 78, 53 from the next desired food item so that those fall through that hole 72, and so on until the desired quantity of each type of individual food item falls into the receipt volume 80). The operation of the respective motors may be rapidly in series, or with a predetermined delay time therebetween, which will provide layers of the different individual food items into the flowing product that flows out of the auger assembly 301 for the user. In other embodiments, the controller 1000 may operate the respective motors 78 of each different storage and metering assembly 40 that holds the desired individual food item simultaneously (either in a batch process or continuously) so that the different desired individual food items are moved to above their respective hole 72 at the same time and therefore fall into the receipt volume 80 at the same time. This may be a batch process—to move the different gears enough to allow one space to be over each respective hole simultaneously, and then wait a time period, and then move each gear 53 a sufficient rotational angle (e.g. between 70 to 80 degrees in embodiments where the gear 53 creates 5 spaces, other angles depending upon the number of spaces in the gear (e.g. between 80 to 100 degrees for a gear with four spaces) to allow the next space to be over each respective hole 72 simultaneously. Alternatively, the controller 1000 may operate the gears 53 simultaneously and continuously, but may slow down the angular velocity of each gear 53 to correctly meter the volume of individual food pieces that fall into the receipt volume 80 as desired. The controller 1000 operates the various motors at a time schedule in order to cause the desired volume and types of individual food items to fall into the auger assembly 301 at a schedule in order to satisfy the desired user input or based upon a recipe.

One of ordinary skill in the art with a thorough review and understanding of the subject specification will be able to program the controller 1000 for the desired operation of each motor 78 for each respective storage and metering assembly 40 to achieve a desired rate of entry of (one or more types of) desired individual food pieces into the auger assembly 301 with only routine optimization, and the controller 1000 may be programmed with various recipes and various operational routines (including the various options discussed in the above paragraph) to achieve the user's desired rate and type of inclusion of individual food items into the auger assembly 301 (and therefore mixed into the flow of flowable food that leaves the auger assembly) with only routine optimization.

The motor 309 is configured to be readily removable from the transmission 310, such as when the housing 101 is desired to be moved off of the top of the machine 10 using the lifting mechanism 501, and the motor 309 can be readily reengaged with the transmission when the housing 101 is restored to the nominal position above the machine 10.

The motor 309 may be operated at intervals that are not associated with the operation of the various storage and metering assemblies 40, such as at predetermined intervals, which serve to generate a force to expel individual food items that have fallen into the auger assembly during times when it is not desired to insert them into a flow of flowable food, which tends to remove the pieces from the auger assembly 301 to avoid unwanted injection of pieces into the flowable food during the next cycle when it is desired to inject individual food pieces.

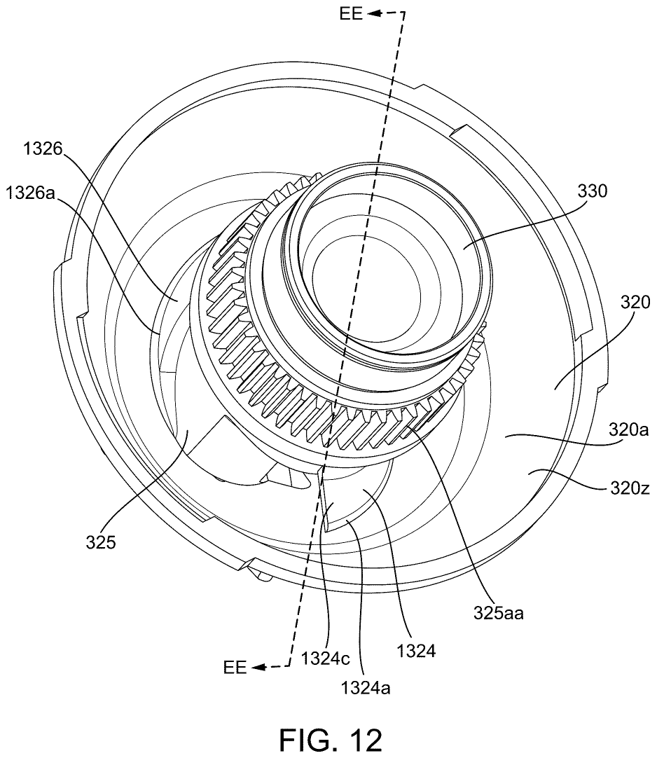

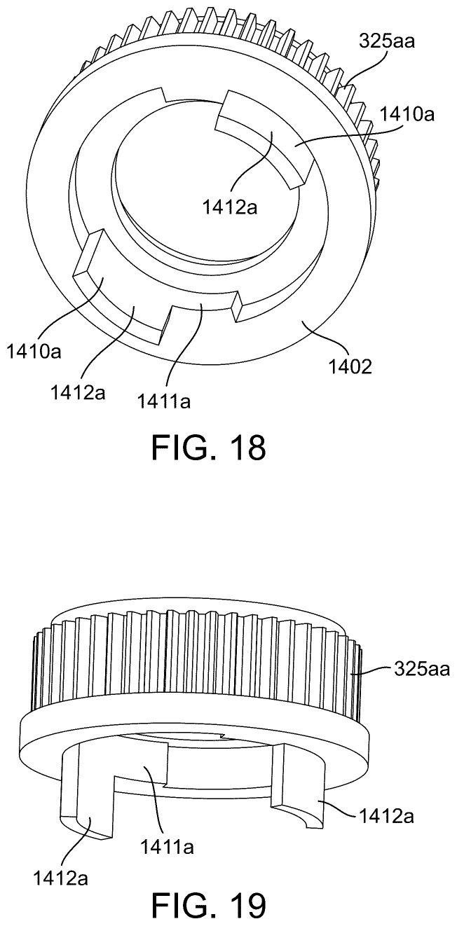

Turning now to FIGS. 12-19 a modified auger system 1300 is provided with an auger housing 320 and a tube 325 with two or more extending threads 1324, 1326 (i.e. “curved paths”) that are similar to threads (curved paths) 324, 326 discussed above. The system is rotated via a transmission 310 using the same structure as discussed with respect to the embodiment.

The threads 1324, 1326 extend from proximate a top portion 320a of the housing 320 and toward the outlet 329 and are fixed to a tube 325 that extends through the housing 320. The threads 1324, 1326 are curved and downwardly extending within the auger housing 320, such that individual food items that are received within the auger assembly 1300 move down the threads toward the outlet 329 as the tube/threads rotate (325, 1324, 1326) with respect to the auger housing 320. The threads 1324, 1326 extend toward an outlet of the tube 325, such that individual food items that travel along the threads 1324, 1326 are directed in a path that leaves the thread downwardly toward the outlet 329 and into the flow of ice cream through the inner volume of the tube 325 to enter into the flowing ice cream. The inner surface of each thread 1324, 1326 is fixed to an outer circumference of the tube 325. The threads include respective outer edges 1324a, 1326a along its length that extends to or to a very close position with respect to an inner side surface of the auger housing 320.

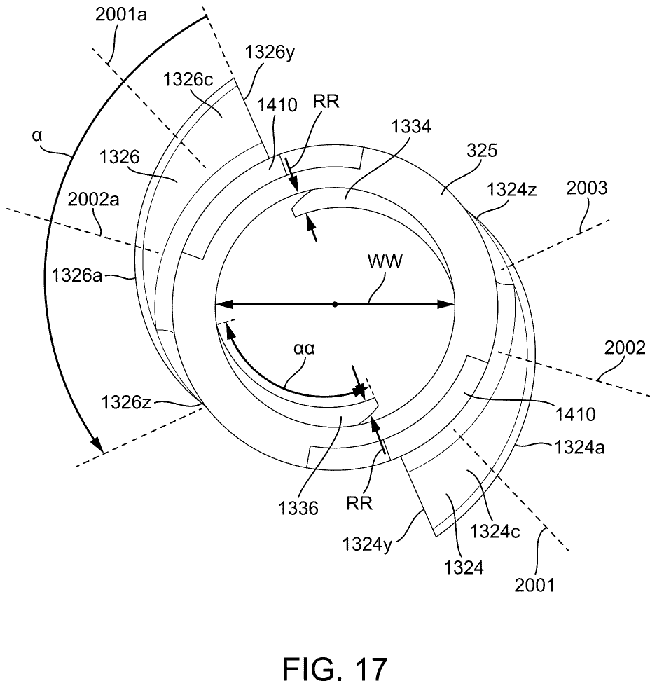

The threads 1324, 1326 may be the same size, shape, and orientation and may be spaced circumferentially apart from each other along the tube 325, such that the threads 1324, 1326 are at spaced circumferential positions along the tube 325. In a representative embodiment with two spaced threads (as depicted in FIGS. 12-19), the threads 1324, 1326 are spaced 180 degrees apart (i.e. the same portion of each thread is 180 degrees from the same portion of the opposite thread) from each other as best shown in FIG. 17. In some embodiments, especially where the threads and the tube are formed as a single piece, each thread extends along an arc of less than 180 degrees, specifically an arc depicted as arc α (FIG. 17), such that no portion of each thread 1324, 1326 is in vertical alignment directly above or directly below any portion of the other thread. This vertical separation may be beneficial for manufacturability purposes (such as molding of the part that defines the tube and the threads) when the threads 1324, 1326 and the tube 325 are formed as a single piece, to prevent the need for the mold to include any undercuts (that would have been necessary to allow for vertically stacked portions of the different threads), which would increase mold complexity. In other embodiments, three (or more) threads may be provided—such as in an embodiment where each thread is spaced 120 degrees (or a needed separation for an embodiment with more than three threads as can be understood by one of ordinary skill after a thorough review of this specification) from an adjacent thread and the arc of the thread (α) is less than 120 degrees (appropriate maximum angular length to avoid vertical stacking of different curved paths) for the purposes described above.

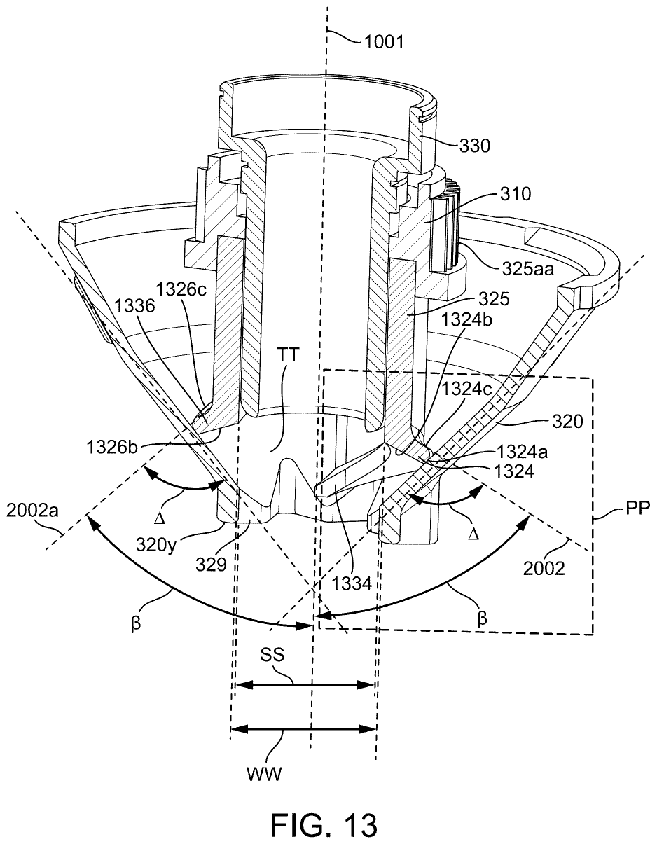

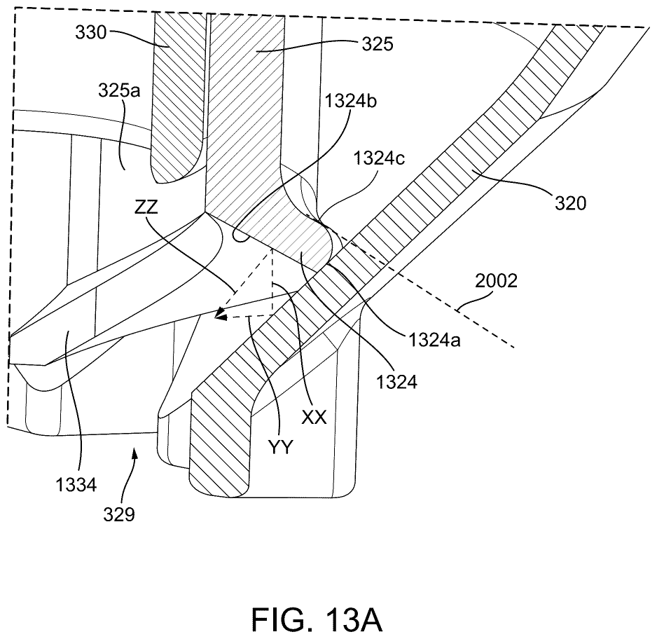

As best depicted in FIGS. 13, 15, 16, and 17, each thread extends from the tube 325 at an acute angle β with respect to a longitudinal axis 1001 that extends through the tube 325. The threads 1324, 1326 may extend along a locally straight surface line that extends along the width of the curved path along an upwardly facing surface (1324c, 1326c) of each thread (i.e. the surface that includes a vector component that extends upwardly parallel to the longitudinal axis 1001 through the tube 325) formed by each thread at the specific position to the tip 1324a, 1326a of the thread, with a continuum of locally straight lines as each thread 1324, 1326 travels along is length (e.g. see localized surface lines 2001, 2002, 2003 along the thread 1324 in FIG. 17, localized lines 2001a, 2002a along thread 1326 in FIG. 17). In a first embodiment the angle β is the same along the entire length of each thread (1324, 1326). In other embodiments, the angle β may change along the length of each thread (e.g. the angle β is largest at the top end (e.g. 1324y) of the thread and smallest at the bottom end (e.g. 1324z)).

Each threads 1324, 1326 is formed such that the localized surface line forms an angle Δ with the proximate inner wall 320z of the housing 320 (measured with respect to the upward facing surface of the thread—see FIG. 13). The angle Δ is a function of the angle of the inner wall 320z makes (at the location where the tip (e.g. 1324a) of the thread contacts or almost reaches that auger housing inner wall) and the angle of the surface of the thread 1324, 1326 along the localized surface line. Due to the orientation of the localized surface lines (e.g. 2001, 2001a) in a downward direction, the angle Δ is larger than it would be if the threads extended such that localized lines were perpendicular to the longitudinal axis 1001 of the tube. In some embodiments, the threads 1324, 1326 extend in an orientation where their localized surface lines extend at a constant angle β along their length, which is within a range of between about 45 to about 80 degrees, preferably within a range of about 60 to about 75 degrees, and in some embodiments at an angle of about 65 degrees, about 70 degrees, or about 75 degrees. In one preferred embodiment the angle of the inner wall 320z that is proximate to where the tips 1324a, 1324b contact or come into close proximity is at constant conical angle along the entire portion were the tips contact or come into close proximity, and in this embodiment, the inner wall 320z is oriented such that the angle Δ is about 110 degrees, in the embodiment where the taper of the inner wall 320z is at about 45 degrees to the longitudinal axis 1001.

With experimenting and testing of the auger system with the threads 1324, 1326 disclosed herein it has been determined that the providing the threads such that locally straight surface lines that extend along the thread (e.g. 2001, 2002, 2003; 2001a, etc.) that are at an acute angle β with respect to the longitudinal axis 1001 (rather than at a perpendicular angle to the longitudinal axis) results in performance improvements of the auger system. Via experimental testing, it has been identified that threads 1324, 1326 that are aligned with the locally straight lines that extend at the acute angle β with respect to the longitudinal axis 1001 result in less buildup of individual food items on the bottom surface 1324b, 1326b of the threads 1324, 1326 than has been identified through testing of embodiments where the threads extend with locally straight lines that extend perpendicularly to the longitudinal axis 1001. It is believed that the buildup is reduced because the angle of the thread with the downwardly extending locally straight surface lines (e.g. 2001, 2002, 2001a) includes a bottom surface 1324b, 1326b that faces with vector components both in the downward direction as well as in the radially inward direction (see FIG. 13A with vector components XX (downward direction) and YY (radially inward direction), with arrow ZZ that is in the direction that the bottom surface 1324b (1326b) faces). The alignment of the bottom surface with an inner facing vector component (YY) results in an inward force being imparted upon individual food items with a component toward the center of a protection within a cross-section of the tube (WW, and below the tube 325), which counteracts the centrifugal force imparted upon the food item due to the rotation of the tube 325 and the threads 1324, 1326, which tends to cause the food item to fall away from sticking to the bottom surface 1324b, 1326b. The inward force component (YY, FIG. 13A) upon the food pieces has also been found to better mix the food pieces into the ice cream that flows out of the tube 325 below the threads 1324, 1326 than with threads with locally straight lines that are horizontal (perpendicular to the axis 1001). Further, the orientation of the threads 1324, 1326 with the downwardly extending locally straight lines (e.g. 2001, 2001a) allows for maximizing the taper angle of the housing 320 and therefore minimizing the height of the housing 320 need to generate an acceptable rotational motion of the individual food pieces. Minimizing the height of the housing 320 (and therefore the tube 325 that the ice cream flows through before interacting with the moving individual food pieces) reduces the volume of ice cream within the tube 325 at any given time, and therefore minimizes the volume of wasted product within the tube when a draw is stopped—due to the residual within the tube when the draw is stopped often melts unless a successive draw occurs a very short time after the last draw is stopped.

With further reference to FIGS. 13-17, a second thread 1334 extends inwardly with respect to the tube proximate to the thread 1324 and a second thread 1336 extends inwardly with respect to the tube proximate to the thread 1326. Each of the second threads 1334, 1336 extend inside a volume projection WW of the inner volume TT of the tube 325 that extends below a bottom surface of the tube 325. The second threads 1334, 1336 therefore interact with an outer portion of the flowing ice cream that flows out of the bottom end of the tube 325, and create some swirling motion of the ice cream that falls out of the tube. As best shown in FIG. 17, in a preferred embodiment, the second threads 1334, 1336 begin at a circumferential location proximate to the circumferential location where the respective threads end (i.e. the lower tip 1324z, 1326z of each thread 1324, 1326), and as depicted in the figures just before the location where the respective threads end. In some embodiments, the second threads 1334, 1336 extend in a same orientation as the threads 1324, 1326—i.e. locally straight lines across a top surface of each second thread 1334, 1336 (see surface lines 2005, 2005a) also extends at an the acute angle β with respect to the longitudinal axis 1001. In some embodiments, the depth (RR) of each second threads 1334, 1336 gradually increases along its length (i.e. the distance inwardly that each second portion extends from a location where the cylindrical inner surface (325b) extends downwardly from the tube 325, i.e. the ends of arrow WW depict the inner diameter of the tube). The second threads each extend along an arc α α (FIG. 17). The arc α α of each second thread 1334, 1336 may be within a range of between about 50 degrees and about 80 degrees, such as at an arc of about 60 degrees, about 70 degrees, or about 80 degrees, and inclusive of all arcs α α within this range.

In a preferred embodiment, the combined thread (e.g. 1324) and the second thread (e.g. 1334) that extends therefrom extends up to a total arc of 180 degrees (or just short of 180 degrees)—for embodiments that include two opposite thread and second thread combinations. As depicted in FIG. 17, a circumferential portion of the arc α of the respective first thread (e.g. 1326 as depicted) extends along the same circumferential portion of the respective second thread (e.g. 1336 as depicted).

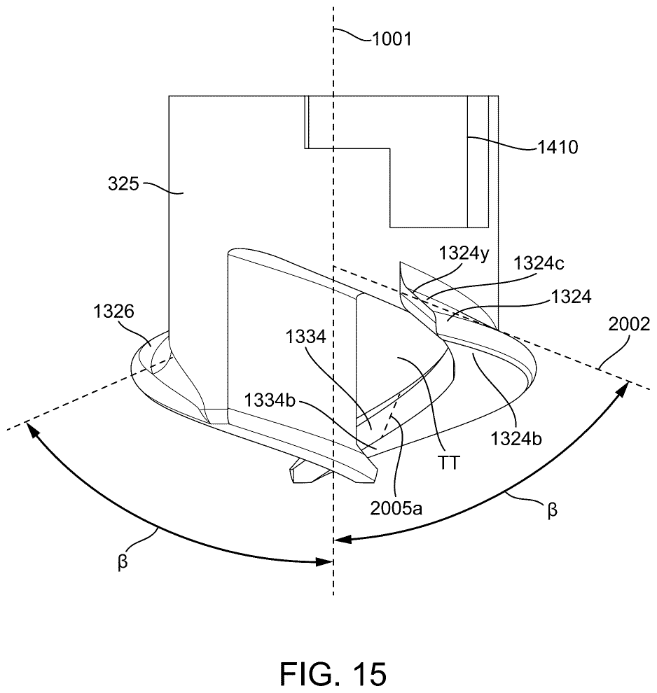

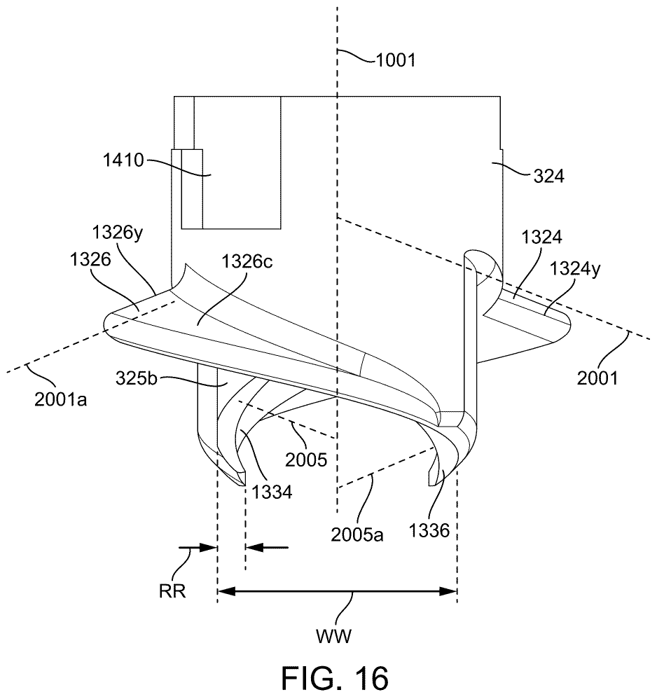

In a preferred embodiment as best shown in FIGS. 15 and 16, a bottom surface of the respective thread (e.g. 1324a of thread 1324 as shown in FIG. 15) and the second thread (e.g. 1334b of thread 1334 as shown in FIG. 15) that extends from the thread is at a continuous curve and forms a continuous surface that extends through both threads. This allows for continuous contact with a food item as the tube 325 rotates between the continuous thread 1326 and the second continuous thread 1336 to best urge the food item in the rotational path as guided by the continuous bottom surfaces.

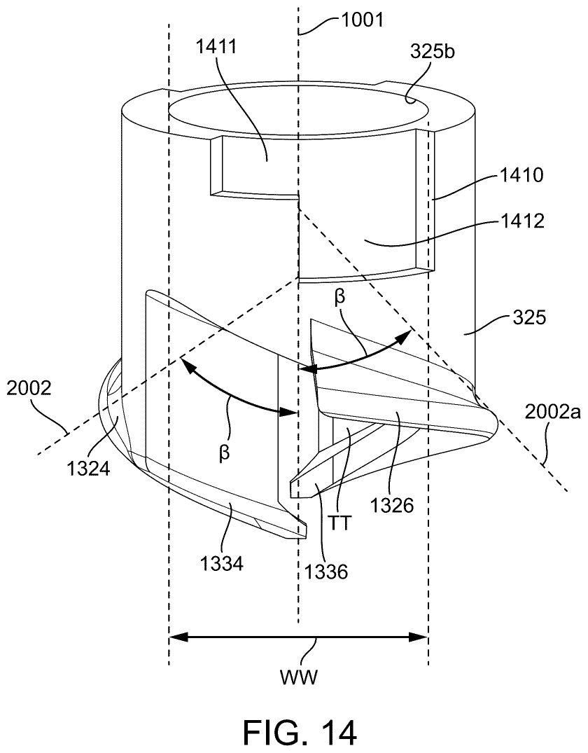

In some embodiments as depicted in FIGS. 14-19, the tube 325 may include two or more cutouts 1410 along a top portion thereof that are configured to receive corresponding projections 1410a within the piece in the transmission that includes gear teeth 325aa that is part of the transmission 310, such that the engagement between the projections 1410a and the cutouts 1410 transfers torque from the gear teeth 325aa to the tube 325. The cutouts 1410 and corresponding projections 1410a may include one or two steps (e.g. 1411/1411a, 1412/1412a) or other corresponding features that slidingly meet each other and provide significant surfaces to transfer torque and are large enough to establish suitably large factor of safety against shear when the transmission is operating in the presence of the highest volume and density of ice cream and food pieces contemplated during operation of the machine.

In a preferred embodiment and as depicted in FIG. 13, a bottom portion 320y of the housing 320 that forms the outlet 329 for ice cream and combined food pieces (which typically in an assembled machine is disposed directly above the draw valve (not shown) forms a uniform diameter (or maximum diameter in embodiments where the outlet is not circular—i.e. a star shape as depicted in the figures)) is sized with a maximum diameter SS that is smaller than the inner diameter of the tube 325 (WW). In a preferred embodiment, the maximum diameter SS is the same distance as the closest position between opposite second threads 1334, 1336 at their most inwardly directed (typically at the end tip of the second threads 1334, 1336 in the embodiments disposed herein). Alternatively the maximum diameter SS may be slightly smaller than the closest position between opposite second threads 1334, 1336. These embodiments provide for better mixing of the ice cream that flows out of the tube 325 and the food pieces that travel with the threads 1324, 1326 and the second threads 1334, 1336 through the housing 320, and specifically by pushing the food pieces inwardly within the flow of the ice cream from the tube 325.

The term “about” is specifically defined herein to include a range that includes the reference value and plus or minus 5% of the reference value. The term “substantially the same” is when the item under comparison is within 5% of the aspect of the reference value of the item. The term “substantially” is when the referenced value or referenced aspect is within 5% of the reference value. For example, if the referenced item is an angle, something is substantially at that angle if it is within plus or minus 5% of the angle. The term “substantially” referenced with respect to a state (e.g. a path being substantially blocked) means that referenced state is blocked but may allow for di minimus flow therepast. The term “substantially” is when the term under comparison is not the exact same item (such as shape or length) as mentioned but with only di minimus changes from the referenced item as those di minimus changes would be appreciated by one or ordinary skill in the art, such as changes that do not significantly affect the structure of function of the item.

The computing elements or functions disclosed herein may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:
Numbered Paragraph 1: An apparatus for injecting food items into a flowable frozen base product, comprising:
a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly;
an auger assembly that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly,
wherein the housing is configured to be movably fixed to a machine that is configured to produce the flowable frozen base product, wherein the housing can be disposed in a use position where the housing rests above the machine and the housing can be disposed in a lowered position wherein the housing is disposed outboard of and in a position wherein the housing is disposed vertically below the use position,
the housing comprises a bracket that is fixed to a surface thereof, the bracket is connected to a lifting mechanism that is configured to be installed upon and fixed to a machine housing of the machine configured to produce the flowable frozen base product,
the bracket can rotate with respect to the lifting mechanism with a rotational axis that is oriented in parallel with a longitudinal axis of motion of the lifting mechanism.
Numbered Paragraph 2: The apparatus of Numbered Paragraph 1, wherein the lifting mechanism comprises an enclosure with an elongate slot disposed through a portion thereof, the elongate slot providing an aperture for extending a flexible elongate member therethrough.
Numbered Paragraph 3: The apparatus of any one of Numbered Paragraphs 1 or 2, wherein the housing is rotated away from the use position, with sufficient rotation the housing is no longer disposed with a portion thereof aligned vertically above the machine, wherein when no longer vertically aligned above the machine, the lifting mechanism allows the bracket and the housing to lower with respect to the machine.
Numbered Paragraph 4: The apparatus of Numbered Paragraph 3, wherein the lifting mechanism includes an assist mechanism, wherein the assist mechanism is aligned to be compressed when the bracket and the housing are lowered with respect to the machine, wherein when the bracket and the housing are in a lowered position, movement to raise the bracket and the housing with respect to the machine allows the assist mechanism to extend wherein the extension of the assist mechanism assists with upward vertical motion of the bracket and the housing with respect to the machine.
Numbered Paragraph 5: The apparatus of any one of Numbered Paragraphs 1-4, wherein the lifting mechanism further comprises a plate that is configured to be fixed to a top surface of the machine when the apparatus is connected to the machine, wherein a bottom surface of the housing is configured to rest upon the plate when the housing is in the use position.
Numbered Paragraph 6: The apparatus of Numbered Paragraph 5, wherein the plate has one of an aperture or a recessed portion that extends downwardly from a top surface of the plate, wherein the bottom surface of the housing comprises a detent, wherein when the housing is in the use position, the detent is in registry with the provided aperture or recessed portion such that the detent extends into the provided aperture or recessed portion.
Numbered Paragraph 7: The apparatus of Numbered Paragraph 5, wherein the plate comprises an aperture disposed therethrough, wherein when the housing is in the use position, an electrical connector upon a bottom surface of the housing is disposed in registry with the aperture, such that a cable can extend through the aperture and connect with the electrical connector.
Numbered Paragraph 8: The apparatus of Numbered Paragraph 7, wherein the electrical connector has a first magnetic connector and the cable has a second magnetic connector with a magnetic polarity opposite to the magnetic polarity of the first magnetic connector, such that the first and second magnetic connectors are held together with a magnetic attractive force.
Numbered Paragraph 9: The apparatus of Numbered Paragraph 8, wherein one or both the electrical connector or the cable have a spring loaded contact that is biased to engage a corresponding contact on the other of the first and second magnetic connector to make an electrical connection there between when the first and second magnetic connectors are magnetically connected together.
Numbered Paragraph 10: The apparatus of Numbered Paragraph 8, wherein the first and second magnetic connectors are configured to disengage when the cable is pulled away from the bottom surface of the housing and the plate.
Numbered Paragraph 11: The apparatus of Numbered Paragraph 8, wherein the first and second magnetic connectors are configured to disengage when the housing is moved with respect to the plate.
Numbered Paragraph 12: The apparatus of any one of Numbered Paragraphs 1-11, wherein each storage and metering assembly comprises a storage volume configured to receive the volume of individual food items, the storage volume comprises one or more mixing fingers that extend therein, wherein the mixing fingers are configured to be movable within the storage volume to agitate the volume of individual food items therein, the storage and metering assembly further comprises a metering volume that is disposed below the storage volume, and wherein a portion of a bottom surface of the storage volume includes a first hole that allows individual food items to fall therethrough and into the metering volume, wherein the metering volume includes a second hole allows individual food items that are above the second hole to fall therethrough and into the receipt volume.
Numbered Paragraph 13: The apparatus of Numbered Paragraph 12, wherein the first hole extends over a portion of the metering volume that is on a first side of a center of the metering volume, and wherein the second hole extends through a portion of the metering volume that is on a second side of the center of the metering volume, wherein the second side is on an opposite side of the center from the first side.
Numbered Paragraph 14: The apparatus of Numbered Paragraph 13, wherein for the metering volume includes a gear disposed therein, the gear has a center hub and at least five teeth that extend radially outward from the center hub, wherein adjacent teeth are positioned at consistent arc lengths from each other for each of the at least five teeth.
Numbered Paragraph 15: The apparatus of Numbered Paragraph 14, wherein a space is formed between adjacent teeth, wherein when a space between adjacent teeth is aligned below the first hole, individual food items that fall through the first hole fall into the space, wherein when the gear is rotated, the individual food items that are between adjacent teeth are moved within the metering volume and toward the second hole, wherein individual food items that are moved to a position above the second hole are configured to fall through the second hole and into the receipt volume.
Numbered Paragraph 16: The apparatus of Numbered Paragraph 14, wherein each storage and metering assembly includes a motor disposed thereupon, wherein a motor shaft transfers torque to both the mixing fingers and the gear simultaneously such that the mixing fingers and the gear are rotated simultaneously when a motor shaft rotates.
Numbered Paragraph 17: The apparatus of Numbered Paragraph 16, wherein the motor is configured to initially rotate in a first rotational direction to transfer the space most proximate to and short of the second hole in the first rotational direction to extend above the second hole, and then rotate in a second rotational direction opposite of the first rotational direction to move the space in the second rotational direction.
Numbered Paragraph 18: The apparatus of Numbered Paragraph 16, further comprising a controller that is in communication with the motor and in communication with an input device associated with the housing, the controller is configured to receive a signal from the input device representative of instructions to mix one or more individual food items that are stored within one or more of the storage and metering assemblies, and upon receipt of the signal the controller communicates with the motors of the one or more respective storage and metering assemblies to direct the respective motor to rotate to cause the gear within the metering volume to similarly rotate.
Numbered Paragraph 19: The apparatus of Numbered Paragraph 18, wherein the controller is further in communication with the machine, wherein the controller receives a signal from the machine that is representative of a draw valve of the machine being opened such that flowable frozen food product flows out of the draw valve and into the auger assembly, wherein the controller does not communicate to the motors of the one or more storage and metering assemblies to direct the respective motor to rotate unless the controller receives the signal from the machine that is representative of the draw valve being opened.
Numbered Paragraph 20: The apparatus of Numbered Paragraph 12, wherein each storage and metering assembly includes a biased pin that extends from a side surface thereon, wherein the housing includes a platform with a plurality of cutouts for the metering volume to extend therethrough, wherein when the metering volume of the respective storage and metering assembly extends through the respective cutout, the biased pin is aligned with a hole within the platform and the biased pin is allowed to extend within the hole.
Numbered Paragraph 21: The apparatus of Numbered Paragraph 20, wherein each cutout of the respective plurality of cutouts includes one or more keyways disposed along a circumference thereof, and the metering portion of each of the storage and metering assembly includes corresponding keys that are sized and shaped to fit within the respective keyways, wherein each respective storage and metering assembly is configured to fit in only a single orientation within each respective cutout.
Numbered Paragraph 22: The apparatus of any one of Numbered Paragraphs 1-21, further comprising a tube that extends from a bottom aperture of the receipt volume to a first inlet within an auger housing of the auger assembly.
Numbered Paragraph 23: The apparatus of Numbered Paragraph 22, wherein the auger assembly includes a second inlet disposed along a centerline of the auger housing, wherein when the auger housing is installed upon the machine, the second inlet is disposed to receive flowing frozen food from the machine, wherein the first inlet is disposed radially outward from the centerline of the auger housing,
wherein the auger assembly includes one or more curved paths that extend in a downward direction within the auger housing, wherein each curved path has an outer edge along its length that extends to or to a very close position with respect to an inner side surface of the auger housing, wherein the one or more curved paths are rotatable within the auger housing.
Numbered Paragraph 24: The apparatus of Numbered Paragraph 23, wherein the one or more curved paths are rotated with torque received via a transmission from a motor.
Numbered Paragraph 25: The apparatus of Numbered Paragraph 24, wherein the one or more curved paths are fixed with respect to a gear that is engaged by a transmission, such that torque received by the transmission is transferred to the gear to cause rotation of the one or more paths.
Numbered Paragraph 26: The apparatus of Numbered Paragraph 25, wherein the motor is removable from the transmission to allow the housing to be moved from the use position to the lowered position.
Numbered Paragraph 27: A method of operating an apparatus in accordance with any one of Numbered Paragraphs 1-26.
Numbered Paragraph 28: An apparatus for injecting food items into a flowable frozen base product, comprising:
a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly;
an auger assembly that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly.
Numbered Paragraph 29: The apparatus of any one of Numbered Paragraph 28, wherein each storage and metering assembly comprises a storage volume configured to receive the volume of individual food items, the storage volume comprises one or more mixing fingers that extend therein, wherein the mixing fingers are configured to be movable within the storage volume to agitate the volume of individual food items therein, the storage and metering assembly further comprises a metering volume that is disposed below the storage volume, and wherein a portion of a bottom surface of the storage volume includes a first hole that allows individual food items to fall therethrough and into the metering volume, wherein the metering volume includes a second hole allows individual food items that are above the second hole to fall therethrough and into the receipt volume.
Numbered Paragraph 30: The apparatus of Numbered Paragraph 29, wherein the first hole extends over a portion of the metering volume that is on a first side of a center of the metering volume, and wherein the second hole extends through a portion of the metering volume that is on a second side of the center of the metering volume, wherein the second side is on an opposite side of the center from the first side.
Numbered Paragraph 31: The apparatus of Numbered Paragraph 30, wherein for the metering volume includes a gear disposed therein, the gear has a center hub and at least five teeth that extend radially outward from the center hub, wherein adjacent teeth are positioned at consistent arc lengths from each other for each of the at least five teeth.
Numbered Paragraph 32: The apparatus of Numbered Paragraph 31, wherein a space is formed between adjacent teeth, wherein when a space between adjacent teeth is aligned below the first hole, individual food items that fall through the first hole fall into the space, wherein when the gear is rotated, the individual food items that are between adjacent teeth are moved within the metering volume and toward the second hole, wherein individual food items that are moved to a position above the second hole are configured to fall through the second hole and into the receipt volume.
Numbered Paragraph 33: The apparatus of Numbered Paragraph 31, wherein each storage and metering assembly includes a motor disposed thereupon, wherein a motor shaft transfers torque to both the mixing fingers and the gear simultaneously such that the mixing fingers and the gear are rotated simultaneously when a motor shaft rotates.
Numbered Paragraph 34: The apparatus of Numbered Paragraph 33, wherein the motor is configured to initially rotate in a first rotational direction to transfer the space most proximate to and short of the second hole in the first rotational direction to extend above the second hole, and then rotate in a second rotational direction opposite of the first rotational direction to move the space in the second rotational direction.
Numbered Paragraph 35: The apparatus of Numbered Paragraph 33, further comprising a controller that is in communication with the motor and in communication with an input device associated with the housing, the controller is configured to receive a signal from the input device representative of instructions to mix one or more individual food items that are stored within one or more of the storage and metering assemblies, and upon receipt of the signal the controller communicates with the motors of the one or more respective storage and metering assemblies to direct the respective motor to rotate to cause the gear within the metering volume to similarly rotate.
Numbered Paragraph 36: The apparatus of Numbered Paragraph 35, wherein the controller is further in communication with the machine, wherein the controller receives a signal from the machine that is representative of a draw valve of the machine being opened such that flowable frozen food product flows out of the draw valve and into the auger assembly, wherein the controller does not communicate to the motors of the one or more storage and metering assemblies to direct the respective motor to rotate unless the controller receives the signal from the machine that is representative of the draw valve being opened.
Numbered Paragraph 37: The apparatus of Numbered Paragraph 29, wherein each storage and metering assembly includes a biased pin that extends from a side surface thereon, wherein the housing includes a platform with a plurality of cutouts for the metering volume to extend therethrough, wherein when the metering volume of the respective storage and metering assembly extends through the respective cutout, the biased pin is aligned with a hole within the platform and the biased pin is allowed to extend within the hole.
Numbered Paragraph 38: The apparatus of Numbered Paragraph 37, wherein each cutout of the respective plurality of cutouts includes one or more keyways disposed along a circumference thereof, and the metering portion of each of the storage and metering assembly includes corresponding keys that are sized and shaped to fit within the respective keyways, wherein each respective storage and metering assembly is configured to fit in only a single orientation within each respective cutout.
Numbered Paragraph 39: The apparatus of any one of Numbered Paragraphs 28-38, further comprising a tube that extends from a bottom aperture of the receipt volume to a first inlet within an auger housing of the auger assembly.
Numbered Paragraph 40: The apparatus of Numbered Paragraph 39, wherein the auger assembly includes a second inlet disposed along a centerline of the auger housing, wherein when the auger housing is installed upon the machine, the second inlet is disposed to receive flowing frozen food from the machine, wherein the first inlet is disposed radially outward from the centerline of the auger housing,
wherein the auger assembly includes one or more curved paths that extend in a downward direction within the auger housing, wherein each curved path has an outer edge along its length that extends to or to a very close position with respect to an inner side surface of the auger housing, wherein the one or more curved paths are rotatable within the auger housing.
Numbered Paragraph 41: The apparatus of Numbered Paragraph 40, wherein the one or more curved paths are rotated with torque received via a transmission from a motor.
Numbered Paragraph 42: The apparatus of Numbered Paragraph 41, wherein the one or more curved paths are fixed with respect to a gear that is engaged by a transmission, such that torque received by the transmission is transferred to the gear to cause rotation of the one or more paths.
Numbered Paragraph 43 The apparatus of Numbered Paragraph 42, wherein the motor is removable from the transmission to allow the housing to be moved from the use position to the lowered position.
Numbered Paragraph 44: The apparatus of any one of Numbered Paragraphs 28-43,
wherein the housing is configured to be movably fixed to a machine that is configured to produce the flowable frozen base product, wherein the housing can be disposed in a use position where the housing rests above the machine and the housing can be disposed in a lowered position wherein the housing is disposed outboard of and in a position wherein the housing is disposed vertically below the use position,
the housing comprises a bracket that is fixed to a surface thereof, the bracket is connected to a lifting mechanism that is configured to be installed upon and fixed to a machine housing of the machine configured to produce the flowable frozen base product,
the bracket can rotate with respect to the lifting mechanism with a rotational axis that is oriented in parallel with a longitudinal axis of motion of the lifting mechanism
Numbered Paragraph 45: The apparatus of Numbered Paragraph 44, wherein the lifting mechanism comprises an enclosure with an elongate slot disposed through a portion thereof, the elongate slot providing an aperture for extending a flexible elongate member therethrough.
Numbered Paragraph 46: The apparatus of any one of Numbered Paragraphs 44 or 45, wherein the housing is rotated away from the use position, with sufficient rotation the housing is no longer disposed with a portion thereof aligned vertically above the machine, wherein when no longer vertically aligned above the machine, the lifting mechanism allows the bracket and the housing to lower with respect to the machine.
Numbered Paragraph 47: The apparatus of Numbered Paragraph 46, wherein the lifting mechanism includes an assist mechanism, wherein the assist mechanism is aligned to be compressed when the bracket and the housing are lowered with respect to the machine, wherein when the bracket and the housing are in a lowered position, movement to raise the bracket and the housing with respect to the machine allows the assist mechanism to extend wherein the extension of the assist mechanism assists with upward vertical motion of the bracket and the housing with respect to the machine.
Numbered Paragraph 48: The apparatus of any one of Numbered Paragraphs 44-47, wherein the lifting mechanism further comprises a plate that is configured to be fixed to a top surface of the machine when the apparatus is connected to the machine, wherein a bottom surface of the housing is configured to rest upon the plate when the housing is in the use position.
Numbered Paragraph 49: The apparatus of Numbered Paragraph 48, wherein the plate has one of an aperture or a recessed portion that extends downwardly from a top surface of the plate, wherein the bottom surface of the housing comprises a detent, wherein when the housing is in the use position, the detent is in registry with the provided aperture or recessed portion such that the detent extends into the provided aperture or recessed portion.
Numbered Paragraph 50: The apparatus of Numbered Paragraph 48, wherein the plate comprises an aperture disposed therethrough, wherein when the housing is in the use position, an electrical connector upon a bottom surface of the housing is disposed in registry with the aperture, such that a cable can extend through the aperture and connect with the electrical connector.
Numbered Paragraph 51: The apparatus of Numbered Paragraph 50, wherein the electrical connector has a first magnetic connector and the cable has a second magnetic connector with a magnetic polarity opposite to the magnetic polarity of the first magnetic connector, such that the first and second magnetic connectors are held together with a magnetic attractive force.
Numbered Paragraph 52: The apparatus of Numbered Paragraph 51, wherein one or both the electrical connector or the cable have a spring loaded contact that is biased to engage a corresponding contact on the other of the first and second magnetic connector to make an electrical connection there between when the first and second magnetic connectors are magnetically connected together.
Numbered Paragraph 53: The apparatus of Numbered Paragraph 51, wherein the first and second magnetic connectors are configured to disengage when the cable is pulled away from the bottom surface of the housing and the plate.
Numbered Paragraph 54: The apparatus of Numbered Paragraph 51, wherein the first and second magnetic connectors are configured to disengage when the housing is moved with respect to the plate.
Numbered Paragraph 55: The apparatus of one or more of Numbered Paragraphs 23-27 or 40-45, wherein the curved paths extend in the downward direction within the auger housing such that a plurality of spaced apart surface lines that each extend radially outward along different portions of an upper facing surface of curved path from a centerline through a center of the inner tube to a tip of the respective curved path each extend at an acute angle with respect to the centerline.
Numbered Paragraph 56: The apparatus of Numbered Paragraph 55, wherein each curved path is formed such that each of the plurality of surface lines along the same curved path each extend at the same acute angle.
Numbered Paragraph 57: The apparatus of either one of Numbered Paragraphs 55-56, wherein each curved path is disposed such that the acute angle of each surface line extends at an angle within the range of within about 60 to about 75 degrees.
Numbered Paragraph 58: The apparatus of any one of Numbered Paragraphs 55-57, further comprising one or more second curved paths, wherein each of the one or more second curved paths extends directly from an end of the one or more curved paths, wherein each second curved path extends inwardly with respect to the auger housing and within a projection of an inner volume of inner tube.
Numbered Paragraph 59: The apparatus of Numbered Paragraph 58, wherein a bottom surface of a curved path and a second curved path that extends direction therefrom forms a continuous curved surface across an entire length of both the curved path and the second curved path.
Numbered Paragraph 60: The apparatus of any one of Numbered Paragraphs 55-59, wherein an outlet aperture of the auger housing extends to a maximum diameter that is the same as or less than a diameter of an inner volume of the inner tube.
Numbered Paragraph 61: A method of operating an apparatus in accordance with any one of Numbered Paragraphs 1-60 or 63 to 85, to produce a flow of flowable frozen base product with a plurality of injected food items therein.
Numbered Paragraph 62: A method of operating an apparatus according to any one of Numbered Paragraphs 1-27 and 44-60, comprising the steps of operating the lift mechanism to move the housing between the use and the lowered position.
Numbered Paragraph 63: An apparatus for injecting food items into a flowable frozen base product, comprising:
a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly;
an auger assembly that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly.
Numbered Paragraph 64: The apparatus of Numbered Paragraph 63 1, wherein the housing is configured to be movably fixed to a machine that is configured to produce the flowable frozen base product, wherein the housing can be disposed in a use position where the housing rests above the machine and the housing can be disposed in a lowered position wherein the housing is disposed outboard of and in a position wherein the housing is disposed vertically below the use position,
the housing comprises a bracket that is fixed to a surface thereof, the bracket is connected to a lifting mechanism that is configured to be installed upon and fixed to a machine housing of the machine configured to produce the flowable frozen base product, the bracket can rotate with respect to the lifting mechanism with a rotational axis that is oriented in parallel with a longitudinal axis of motion of the lifting mechanism.
Numbered Paragraph 65: The apparatus of either of Numbered Paragraph 63 or 64, wherein each storage and metering assembly comprises a storage volume configured to receive the volume of individual food items, the storage volume comprises one or more mixing fingers that extend therein, wherein the mixing fingers are configured to be movable within the storage volume to agitate the volume of individual food items therein, the storage and metering assembly further comprises a metering volume that is disposed below the storage volume, and wherein a portion of a bottom surface of the storage volume includes a first hole that allows individual food items to fall therethrough and into the metering volume, wherein the metering volume includes a second hole allows individual food items that are above the second hole to fall therethrough and into the receipt volume.
Numbered Paragraph 66: The apparatus of Numbered Paragraph 65, wherein the first hole extends over a portion of the metering volume that is on a first side of a center of the metering volume, and wherein the second hole extends through a portion of the metering volume that is on a second side of the center of the metering volume, wherein the second side is on an opposite side of the center from the first side.
Numbered Paragraph 67: The apparatus of Numbered Paragraph 66, wherein for the metering volume includes a gear disposed therein, the gear has a center hub and at least five teeth that extend radially outward from the center hub, wherein adjacent teeth are positioned at consistent arc lengths from each other for each of the at least five teeth.
Numbered Paragraph 68: The apparatus of Numbered Paragraph 67, wherein a space is formed between adjacent teeth, wherein when a space between adjacent teeth is aligned below the first hole, individual food items that fall through the first hole fall into the space, wherein when the gear is rotated, the individual food items that are between adjacent teeth are moved within the metering volume and toward the second hole, wherein individual food items that are moved to a position above the second hole are configured to fall through the second hole and into the receipt volume.
Numbered Paragraph 69: The apparatus of either of Numbered Paragraph 67 or 68, wherein each storage and metering assembly includes a motor disposed thereupon, wherein a motor shaft transfers torque to both the mixing fingers and the gear simultaneously such that the mixing fingers and the gear are rotated simultaneously when a motor shaft rotates.

Numbered Paragraph 70: The apparatus of Numbered Paragraph 69, wherein the motor is configured to initially rotate in a first rotational direction to transfer the space most proximate to and short of the second hole in the first rotational direction to extend above the second hole, and then rotate in a second rotational direction opposite of the first rotational direction to move the space in the second rotational direction.
Numbered Paragraph 71: The apparatus of Numbered Paragraph 70, further comprising a controller that is in communication with the motor and in communication with an input device associated with the housing, the controller is configured to receive a signal from the input device representative of instructions to mix one or more individual food items that are stored within one or more of the storage and metering assemblies, and upon receipt of the signal the controller communicates with the motors of the one or more respective storage and metering assemblies to direct the respective motor to rotate to cause the gear within the metering volume to similarly rotate.
Numbered Paragraph 72: The apparatus of Numbered Paragraph 71, wherein the controller is further in communication with the machine, wherein the controller receives a signal from the machine that is representative of a draw valve of the machine being opened such that flowable frozen food product flows out of the draw valve and into the auger assembly, wherein the controller does not communicate to the motors of the one or more storage and metering assemblies to direct the respective motor to rotate unless the controller receives the signal from the machine that is representative of the draw valve being opened.
Numbered Paragraph 73: The apparatus of any one of Numbered Paragraphs 65-72, wherein each storage and metering assembly includes a biased pin that extends from a side surface thereon, wherein the housing includes a platform with a plurality of cutouts for the metering volume to extend therethrough, wherein when the metering volume of the respective storage and metering assembly extends through the respective cutout, the biased pin is aligned with a hole within the platform and the biased pin is allowed to extend within the hole.
Numbered Paragraph 74: The apparatus of Numbered Paragraph 73, wherein each cutout of the respective plurality of cutouts includes one or more keyways disposed along a circumference thereof, and the metering portion of each of the storage and metering assembly includes corresponding keys that are sized and shaped to fit within the respective keyways, wherein each respective storage and metering assembly is configured to fit in only a single orientation within each respective cutout.
Numbered Paragraph 75: The apparatus of any one of Numbered Paragraphs 63 to 74, further comprising a tube that extends from a bottom aperture of the receipt volume to a first inlet and an inner tube that extends through an auger housing of the auger assembly.
Numbered Paragraph 76: The apparatus of Numbered Paragraph 75, wherein the auger assembly includes a second inlet disposed along a centerline of the auger housing, wherein when the auger housing is installed upon the machine, the second inlet is disposed to receive flowing frozen food from the machine, wherein the first inlet is disposed radially outward from the centerline of the auger housing,
wherein the auger assembly includes one or more curved paths that extend in a downward direction within the auger housing, wherein each curved path has an outer edge along its length that extends to or to a very close position with respect to an inner side surface of the auger housing, wherein the one or more curved paths are rotatable within the auger housing.
Numbered Paragraph 77: The apparatus of Numbered Paragraph 76, wherein the one or more curved paths are rotated with torque received via a transmission from a motor.
Numbered Paragraph 78: The apparatus of Numbered Paragraph 77, wherein the one or more curved paths are fixed with respect to a gear that is engaged by a transmission, such that torque received by the transmission is transferred to the gear to cause rotation of the one or more paths.
Numbered Paragraph 79: The apparatus of Numbered Paragraph 78, wherein the motor is removable from the transmission to allow the housing to be moved from the use position to the lowered position.
Numbered Paragraph 80: The apparatus of any one of Numbered Paragraphs 76-79, wherein the curved paths extend in the downward direction within the auger housing such that a plurality of spaced apart surface lines that each extend radially outward along different portions of an upper facing surface of curved path from a centerline through a center of the inner tube to a tip of the respective curved path each extend at an acute angle with respect to the centerline.
Numbered Paragraph 81: The apparatus of Numbered Paragraph 80, wherein each curved path is formed such that each of the plurality of surface lines along the same curved path each extend at the same acute angle.
Numbered Paragraph 82: The apparatus of either of Numbered Paragraphs 80 or 81, wherein each curved path is disposed such that the acute angle of each surface line extends at an angle within the range of within about 60 to about 75 degrees.
Numbered Paragraph 83: The apparatus of any one of Numbered Paragraphs 80-82, further comprising one or more second curved paths, wherein each of the one or more second curved paths extends directly from an end of the one or more curved paths, wherein each second curved path extends inwardly with respect to the auger housing and within a projection of an inner volume of inner tube.
Numbered Paragraph 84: The apparatus of Numbered Paragraph 83, wherein a bottom surface of a curved path and a second curved path that extends direction therefrom forms a continuous curved surface across an entire length of both the curved path and the second curved path.
Numbered Paragraph 85: The apparatus of any one of Numbered Paragraphs 76-84, wherein an outlet aperture of the auger housing extends to a maximum diameter that is the same as or less than a diameter of an inner volume of the inner tube.

1. An apparatus for injecting food items into a flowable frozen base product, comprising:
a housing comprising a plurality of separate storage and metering assemblies therein, each storage and metering assembly is configured to receive a volume of individual food items therein, the housing further comprising a receipt volume that is aligned with an output of individual food items from each of the plurality of storage and metering assembly;
an auger assembly that receives food product from an outlet of the receipt volume and during operation of the auger assembly combines the individual food items received therein with a flowable frozen food product that is received within the auger assembly such that a mixture of the flowable frozen food product and the individual food items flows out of the auger assembly.

2. The apparatus of claim 1, wherein the housing is configured to be movably fixed to a machine that is configured to produce the flowable frozen base product, wherein the housing can be disposed in a use position where the housing rests above the machine and the housing can be disposed in a lowered position wherein the housing is disposed outboard of and in a position wherein the housing is disposed vertically below the use position,
the housing comprises a bracket that is fixed to a surface thereof, the bracket is connected to a lifting mechanism that is configured to be installed upon and fixed to a machine housing of the machine configured to produce the flowable frozen base product, the bracket can rotate with respect to the lifting mechanism with a rotational axis that is oriented in parallel with a longitudinal axis of motion of the lifting mechanism.

3. The apparatus of claim 1, wherein each storage and metering assembly comprises a storage volume configured to receive the volume of individual food items, the storage volume comprises one or more mixing fingers that extend therein, wherein the mixing fingers are configured to be movable within the storage volume to agitate the volume of individual food items therein, the storage and metering assembly further comprises a metering volume that is disposed below the storage volume, and wherein a portion of a bottom surface of the storage volume includes a first hole that allows individual food items to fall therethrough and into the metering volume, wherein the metering volume includes a second hole allows individual food items that are above the second hole to fall therethrough and into the receipt volume.

4. The apparatus of claim 3, wherein the first hole extends over a portion of the metering volume that is on a first side of a center of the metering volume, and wherein the second hole extends through a portion of the metering volume that is on a second side of the center of the metering volume, wherein the second side is on an opposite side of the center from the first side.

5. The apparatus of claim 4, wherein for the metering volume includes a gear disposed therein, the gear has a center hub and at least five teeth that extend radially outward from the center hub, wherein adjacent teeth are positioned at consistent arc lengths from each other for each of the at least five teeth.

6. The apparatus of claim 5, wherein a space is formed between adjacent teeth, wherein when a space between adjacent teeth is aligned below the first hole, individual food items that fall through the first hole fall into the space, wherein when the gear is rotated, the individual food items that are between adjacent teeth are moved within the metering volume and toward the second hole, wherein individual food items that are moved to a position above the second hole are configured to fall through the second hole and into the receipt volume.

7. The apparatus of claim 5, wherein each storage and metering assembly includes a motor disposed thereupon, wherein a motor shaft transfers torque to both the mixing fingers and the gear simultaneously such that the mixing fingers and the gear are rotated simultaneously when a motor shaft rotates.

8. The apparatus of claim 7, wherein the motor is configured to initially rotate in a first rotational direction to transfer the space most proximate to and short of the second hole in the first rotational direction to extend above the second hole, and then rotate in a second rotational direction opposite of the first rotational direction to move the space in the second rotational direction.

9. The apparatus of claim 7, further comprising a controller that is in communication with the motor and in communication with an input device associated with the housing, the controller is configured to receive a signal from the input device representative of instructions to mix one or more individual food items that are stored within one or more of the storage and metering assemblies, and upon receipt of the signal the controller communicates with the motors of the one or more respective storage and metering assemblies to direct the respective motor to rotate to cause the gear within the metering volume to similarly rotate.

10. The apparatus of claim 9, wherein the controller is further in communication with the machine, wherein the controller receives a signal from the machine that is representative of a draw valve of the machine being opened such that flowable frozen food product flows out of the draw valve and into the auger assembly, wherein the controller does not communicate to the motors of the one or more storage and metering assemblies to direct the respective motor to rotate unless the controller receives the signal from the machine that is representative of the draw valve being opened.

11. The apparatus of claim 3, wherein each storage and metering assembly includes a biased pin that extends from a side surface thereon, wherein the housing includes a platform with a plurality of cutouts for the metering volume to extend therethrough, wherein when the metering volume of the respective storage and metering assembly extends through the respective cutout, the biased pin is aligned with a hole within the platform and the biased pin is allowed to extend within the hole.

12. The apparatus of claim 11, wherein each cutout of the respective plurality of cutouts includes one or more keyways disposed along a circumference thereof, and the metering portion of each of the storage and metering assembly includes corresponding keys that are sized and shaped to fit within the respective keyways, wherein each respective storage and metering assembly is configured to fit in only a single orientation within each respective cutout.

13. The apparatus of claim 1, further comprising a tube that extends from a bottom aperture of the receipt volume to a first inlet and an inner tube that extends through an auger housing of the auger assembly.

14. The apparatus of claim 13, wherein the auger assembly includes a second inlet disposed along a centerline of the auger housing, wherein when the auger housing is installed upon the machine, the second inlet is disposed to receive flowing frozen food from the machine, wherein the first inlet is disposed radially outward from the centerline of the auger housing,
wherein the auger assembly includes one or more curved paths that extend in a downward direction within the auger housing, wherein each curved path has an outer edge along its length that extends to or to a very close position with respect to an inner side surface of the auger housing, wherein the one or more curved paths are rotatable within the auger housing.

15. The apparatus of claim 14, wherein the one or more curved paths are rotated with torque received via a transmission from a motor.

16. The apparatus of claim 15, wherein the one or more curved paths are fixed with respect to a gear that is engaged by a transmission, such that torque received by the transmission is transferred to the gear to cause rotation of the one or more paths.

17. The apparatus of claim 16, wherein the motor is removable from the transmission to allow the housing to be moved from the use position to the lowered position.

18. The apparatus of claim 14, wherein the curved paths extend in the downward direction within the auger housing such that a plurality of spaced apart surface lines that each extend radially outward along different portions of an upper facing surface of curved path from a centerline through a center of the inner tube to a tip of the respective curved path each extend at an acute angle with respect to the centerline.

19. The apparatus of claim 18, wherein each curved path is formed such that each of the plurality of surface lines along the same curved path each extend at the same acute angle.

20. The apparatus of claim 18, wherein each curved path is disposed such that the acute angle of each surface line extends at an angle within the range of within about 60 to about 75 degrees.

21. The apparatus of claim 18, further comprising one or more second curved paths, wherein each of the one or more second curved paths extends directly from an end of the one or more curved paths, wherein each second curved path extends inwardly with respect to the auger housing and within a projection of an inner volume of inner tube.

22. The apparatus of claim 21, wherein a bottom surface of a curved path and a second curved path that extends direction therefrom forms a continuous curved surface across an entire length of both the curved path and the second curved path.

23. The apparatus of claim 14, wherein an outlet aperture of the auger housing extends to a maximum diameter that is the same as or less than a diameter of an inner volume of the inner tube.
